(19) United States
(12) Patent Application Publication
(10) Pub. No.: US 2026/0329135 A1
(43) Pub. Date: Oct. 22, 2026

(54) Dimming Panel and Method for Manufacturing the Same, and Dimming Structure

(71) Applicants: BEIJING BOE OPTOELECTRONICS TECHNOLOGY CO.,LTD., Beijing (CN); BOE TECHNOLOGY GROUP CO., LTD., Chaoyang District, Beijing (CN); BEIJING BOE TECHNOLOGY DEVELOPMENT CO., LTD., Beijing (CN)

(72) Inventors: Yanliang Zhan, Beijing (CN); Tonghu Sun, Beijing (CN); Liang Sun, Beijing (CN); Yifeng Qin, Beijing (CN); Naisheng Li, Beijing (CN); Changyin Wang, Beijing (CN); Lei Zhu, Beijing (CN)

(21) Appl. No.: 19/491,075

(22) PCT Filed: May 14, 2024
(86) PCT No.: PCT/CN2024/093231

§ 371 Date: Dec. 8, 2025

(30) Foreign Application Priority Data
Jun. 12, 2023 (CN) 202310696654.1

(51) Int. Cl. G02F 1/1339

(52) U.S. Cl. CPC G02F 1/1339

(57) ABSTRACT

A method for manufacturing a dimming panel includes forming a dimming panel motherboard including a first substrate motherboard, a second substrate motherboard, and a dye liquid crystal layer located therebetween; cutting the dimming panel motherboard to form an initial dimming panel including a first transition plate and a second transition plate; cutting the second transition plate along a first cutting line to form a second substrate exposing a first bonding region of the first transition plate; and forming a first edge sealant including a first sub-portion along the first cutting line. At least part of a sidewall of the first transition plate is flush with at least part of a sidewall of the dye liquid crystal layer. The first sub-portion is located between the first transition plate and the second substrate and is disposed along an edge of the second substrate proximate to the first bonding region.

### CROSS-REFERENCE TO RELATED APPLICATIONS

This application is the U.S. national phase of International Patent Application No. PCT/CN2024/093231 filed May 14, 2024, and claims priority to Chinese Patent Application No. 202310696654.1, filed Jun. 12, 2023, the disclosures of which are hereby incorporated by reference in their entireties.

### BACKGROUND OF THE INVENTION

### Field of the Invention

The present disclosure relates to the field of dimming technologies, and in particular, to a dimming panel and a method for manufacturing the same, and a dimming structure.

### Description of Related Art

Dimming panels have been widely used in fields such as residential buildings, rail transit vehicles, automobiles and agricultural greenhouses due to privacy protection, projection characteristics, environmental protection, sound insulation and other advantages.

### SUMMARY OF THE INVENTION

In another aspect, a method for manufacturing a dimming panel is provided. The method includes following steps. A dimming panel motherboard is formed, where the dimming panel motherboard includes a first substrate motherboard, a second substrate motherboard, a dye liquid crystal layer and a frame sealant; the first substrate motherboard and the second substrate motherboard are disposed opposite to each other; the dye liquid crystal layer is located between the first substrate motherboard and the second substrate motherboard; and the frame sealant is located between the first substrate motherboard and the second substrate motherboard and surrounds the dye liquid crystal layer. The dimming panel motherboard is cut to form an initial dimming panel, where the initial dimming panel includes a first transition plate and a second transition plate, an orthographic projection of the second transition plate on a reference plane coincides with an orthographic projection of the first transition plate on the reference plane, and at least part of a sidewall of the first transition plate is flush with at least part of a sidewall of the dye liquid crystal layer; the reference plane is parallel to a surface of the first substrate motherboard proximate to the dye liquid crystal layer. The second transition plate is cut along a first cutting line to form a second substrate, where the second substrate exposes a first region of the first transition plate, the first region forms a first bonding region; and the dye liquid crystal layer is located between the first transition plate and the second substrate. A first edge sealant is formed along the first cutting line, where the first edge sealant includes a first sub-portion, and the first sub-portion is located between the first transition plate and the second substrate and is disposed along an edge of the second substrate proximate to the first bonding region.

In some embodiments, an orthographic projection of the first cutting line on the reference plane is located in an orthographic projection of the frame sealant on the reference plane.

In some embodiments, forming the first edge sealant along the first cutting line includes: removing a portion of the frame sealant located on a side of the first cutting line away from the dye liquid crystal layer along the first cutting line, where a portion of the frame sealant located between the first cutting line and a side of the dye liquid crystal layer forms the first sub-portion.

In some embodiments, an orthographic projection of the first cutting line on the reference plane is located in an orthographic projection of the dye liquid crystal layer on the reference plane.

In some embodiments, forming the first edge sealant along the first cutting line includes: applying glue to form the first edge sealant, where a portion of the glue located between the dye liquid crystal layer and the first cutting line forms the first sub-portion; the first edge sealant further includes a second sub-portion, and another portion of the glue located in the first bonding region and extending along a sidewall of the second substrate proximate to the first bonding region forms the second sub-portion; the second sub-portion is connected to the first sub-portion.

In some embodiments, after forming the first edge sealant along the first cutting line, the method further includes bonding a first circuit board to the first bonding region of the first transition plate, wherein the first circuit board and the first edge sealant have a gap therebetween.

In some embodiments, after bonding the first circuit board to the first bonding region of the first transition plate, the method further includes forming a first protective adhesive between the first circuit board and the first edge sealant, where the first protective adhesive is bonded to the first edge sealant and the first circuit board, and the first protective adhesive also covers a second region, and a region of the first bonding region exposed by the first circuit board and the first edge sealant forms the second region.

In some embodiments, cutting the dimming panel motherboard to form the initial dimming panel includes: pressing the dimming panel motherboard using a holddown; and cutting the dimming panel motherboard along a second cutting line to form the initial dimming panel, wherein the holddown and the second cutting line have a gap therebetween.

In some embodiments, during cutting the second transition plate to form the second substrate, the second transition plate is cut along an outer edge of the holddown. The second substrate further exposes a third region of the first transition plate, and a width of the third region is smaller than a width of the first region. The second substrate has a second sidewall, the first transition plate has a first sidewall, the second sidewall is substantially parallel to the first sidewall, and an orthographic projection of the second sidewall on the first transition plate and the first sidewall have a gap therebetween. During forming the first edge sealant, the method further includes: applying glue to form a second edge sealant, where the second edge sealant includes a third sub-portion and a fourth sub-portion, a portion of the glue located between the dye liquid crystal layer and the second sidewall forms the third sub-portion, and another portion of the glue located in the third region and extending along the second sidewall forms the fourth sub-portion. The fourth sub-portion is bonded to the second sidewall and connected to the third sub-portion, and an orthographic projection of the fourth sub-portion on the first transition plate covers the third region.

In some embodiments, the second substrate has a fourth sidewall, the first substrate motherboard has a third sidewall, the third sidewall is substantially parallel to the fourth sidewall, and an orthographic projection of the third sidewall on the reference plane coincides with an orthographic projection of the fourth sidewall on the reference plane. During forming the first edge sealant, the method further includes: applying glue to form a third edge sealant, where the third edge sealant includes a fifth sub-portion and a sixth sub-portion, a portion of the glue located between the dye liquid crystal layer and the third sidewall forms the fifth sub-portion, and another portion of the glue extending along the third sidewall and the fourth sidewall forms the sixth sub-portion. The sixth sub-portion is bonded to the third sidewall and the fourth sidewall, and connected to the fifth sub-portion.

In some embodiments, cutting the dimming panel motherboard to form the initial dimming panel includes: cutting the dimming panel motherboard along a third cutting line to form a first dimming panel, where the first dimming panel has a panel region and a liquid leakage region, the liquid leakage region is located on at least one side of the panel region, and in the liquid leakage region, the dye liquid crystal layer and the frame sealant are not provided between the first substrate motherboard and the second substrate motherboard; and cutting the first dimming panel along a fourth cutting line to form the initial dimming panel, where the fourth cutting line is located in the panel region.

In some embodiments, the first substrate motherboard has a fifth sidewall, the second substrate has a sixth sidewall, and the fifth sidewall is substantially parallel to the sixth sidewall. An orthographic projection of the fifth sidewall on the first substrate motherboard, an orthographic projection of the sixth sidewall on the first substrate motherboard, and an orthographic projection of part of the sidewall of the dye liquid crystal layer are substantially flush. During forming the first edge sealant, the method further includes: applying glue to form a fourth edge sealant, wherein the glue forms the fourth edge sealant extending along the fifth sidewall, the sixth sidewall and the sidewall of the dye liquid crystal layer, and the fourth edge sealant is bonded to the fifth sidewall and the sixth sidewall.

In some embodiments, the dimming panel motherboard further includes a plurality of spacers, and the plurality of spacers are located between the first substrate motherboard and the second substrate motherboard. Forming the dimming panel motherboard includes: forming an initial support layer on the first substrate motherboard; performing direct-write exposure on the initial support layer using a digital mask; and performing developing, cleaning and curing on the initial support layer to form the plurality of spacers.

In another aspect, a dimming panel is provided. The dimming panel includes a first substrate, a second substrate, a dye liquid crystal layer, a plurality of spacers and a first edge sealant. The first substrate and the second substrate are disposed opposite to each other. The first substrate has a first bonding region, and an orthographic projection of the second substrate on the first substrate does not overlap with the first bonding region. The dye liquid crystal layer is located between the first substrate and the second substrate. The plurality of spacers are located between the first substrate and the second substrate. The first edge sealant includes a first sub-portion, and the first sub-portion is located between the first substrate and the second substrate and is disposed along an edge of the second substrate proximate to the first bonding region.

In some embodiments, the first edge sealant further includes a second sub-portion. An orthographic projection of the second sub-portion on the first substrate is located within the first bonding region, the second sub-portion is disposed along an edge of the first bonding region proximate to the second substrate, and is connected to a sidewall of the first sub-portion proximate to the first bonding region and bonded to a sidewall of the second substrate proximate to the first bonding region.

In some embodiments, the dimming panel further includes a first circuit board and a first protective adhesive. An orthographic projection of the first circuit board on the first substrate is located within the first bonding region. At least a portion of the first protective adhesive is located between the first edge sealant and the first circuit board and is bonded to the first edge sealant and the first circuit board.

In some embodiments, a region constituted by orthographic projections of the first edge sealant, the first protective adhesive and the first circuit board on the first substrate covers the first bonding region.

In some embodiments, the first substrate has a first sidewall, the second substrate has a second sidewall, the second sidewall is substantially parallel to the first sidewall, and an orthographic projection of the second sidewall on the first substrate and the first sidewall have a gap therebetween. The dimming panel further includes a second edge sealant. The second edge sealant includes a third sub-portion and a fourth sub-portion, where the third sub-portion is located between the first substrate and the second substrate and disposed along an edge of the second substrate proximate to the second sidewall, and the fourth sub-portion is disposed along the second sidewall, and is bonded to the second sidewall and connected to a sidewall of the third sub-portion proximate to the fourth sub-portion. An orthographic projection of the fourth sub-portion on the first substrate covers a region between an orthographic projection of the first sidewall on the first substrate and the orthographic projection of the second sidewall on the first substrate.

In some embodiments, the first substrate has a third sidewall, the second substrate has a fourth sidewall, the third sidewall is substantially parallel to the fourth sidewall, and an orthographic projection of the third sidewall on the first substrate coincides with an orthographic projection of the fourth sidewall on the first substrate. The dimming panel further includes a third edge sealant. The third edge sealant includes a fifth sub-portion, where the fifth sub-portion is located between the first substrate and the second substrate and is disposed along an edge of the first substrate proximate to the third sidewall.

In some embodiments, the third edge sealant further includes a sixth sub-portion. The sixth sub-portion is disposed along the third sidewall and the fourth sidewall, and is bonded to the third sidewall and the fourth sidewall and connected to a sidewall of the fifth sub-portion proximate to the third sidewall.

In some embodiments, the second substrate has a second bonding region, and an orthographic projection of the first substrate on the second substrate does not overlap with the second bonding region. The dimming panel further includes a fifth edge sealant and a second circuit board. The fifth edge sealant includes a seventh sub-portion and an eighth sub-portion. The seventh sub-portion is located between the first substrate and the second substrate and disposed along an edge of the first substrate proximate to the second bonding region. An orthographic projection of the eighth sub-portion on the second substrate is located within the second bonding region; the eighth sub-portion is disposed along an edge of the second bonding region proximate to the first substrate, and is connected to a sidewall of the seventh sub-portion proximate to the second bonding region and bonded to a sidewall of the first substrate proximate to the second bonding region. An orthographic projection of the second circuit board on the second substrate is located within the second bonding region.

In some embodiments, the dimming panel further includes a second protective adhesive, and at least a portion of the second protective adhesive is located between the fifth edge sealant and the second circuit board and is bonded to the fifth edge sealant and the second circuit board.

In some embodiments, a region constituted by orthographic projections of the fifth edge sealant, the second protective adhesive and the second circuit board on the second substrate covers the second bonding region.

In some embodiments, the second substrate includes a second base and a second electrode layer. The second base is provided with a through hole therein.

The second electrode layer is located on a side of the second base proximate to the dye liquid crystal layer, and the second electrode layer covers the second base. The dimming panel further includes a second circuit board. The second circuit board is located on a side of the second substrate away from the first substrate, and at least a portion of the second circuit board passes through the through hole to be electrically connected to the second electrode layer.

In some embodiments, the spacers are disposed on the first substrate, and at least part of orthographic projections of the spacers on a plane where the second substrate is located are located outside the second substrate.

In some embodiments, at least one spacer is located in the first bonding region.

In another aspect, a dimming structure is provided. The dimming structure includes: the dimming panel as described in any of the above embodiments, and the dimming structure includes at least one of a curtain wall, a daylighting roof, a rail transit vehicle and a passenger vehicle.

### BRIEF DESCRIPTION OF THE DRAWINGS

In order to describe technical solutions in the present disclosure more clearly, accompanying drawings to be used in some embodiments of the present disclosure will be introduced briefly below. Obviously, the accompanying drawings to be described below are merely accompanying drawings of some embodiments of the present disclosure, and a person of ordinary skill in the art may obtain other drawings according to these drawings. In addition, the accompanying drawings to be described below may be regarded as schematic diagrams, but are not limitations on an actual size of a product, an actual process of a method and an actual timing of a signal to which the embodiments of the present disclosure relate.

FIGS. 1A to 16B are diagrams showing steps in a method for manufacturing a dimming panel, in accordance with some embodiments;

FIG. 17 is a structural diagram of arrangement on the same side of a first circuit board and a second circuit board, in accordance with some embodiments;

FIG. 18A is a cross-sectional view taken along a section line I-I in FIG. 17;

FIG. 18B is another cross-sectional view taken along a section line I-I in FIG. 17;

FIG. 18C is another cross-sectional view taken along a section line I-I in FIG. 17;

FIG. 18D is another cross-sectional view taken along a section line I-I in FIG. 17;

FIG. 18E is another cross-sectional view taken along a section line I-I in FIG. 17;

FIG. 18F is another cross-sectional view taken along a section line I-I in FIG. 17;

FIG. 18G is another cross-sectional view taken along a section line I-I in FIG. 17;

FIG. 18H is another cross-sectional view taken along a section line I-I in FIG. 17;

FIG. 19 is a cross-sectional view taken along a section line J-J in FIG. 17;

FIG. 20 is a structural diagram of adjacent arrangement of a first circuit board and a second circuit board, in accordance with some embodiments;

FIG. 21 is a structural diagram of opposite arrangement of a first circuit board and a second circuit board, in accordance with some embodiments;

FIG. 22 is a structural diagram of sizes of a first bonding region and a second bonding region, in accordance with some embodiments;

FIG. 23 is a structural diagram of a second base provided with a through hole, in accordance with some embodiments; and

FIG. 24 is a structural diagram of a vehicle, in accordance with some embodiments.

### DESCRIPTION OF THE INVENTION

Technical solutions in some embodiments of the present disclosure will be described clearly and completely with reference to the accompanying drawings below. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as open and inclusive, i.e., “including, but not limited to”. In the description of the specification, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics described herein may be included in any one or more embodiments or examples in any suitable manner.

Hereinafter, the terms such as “first” and “second” are used for descriptive purposes only, and are not to be construed as indicating or implying the relative importance or implicitly indicating the number of indicated technical features. Thus, features defined with “first” or “second” may explicitly or implicitly include one or more of the features. In the description of the embodiments of the present disclosure, the term “a plurality of” or “the plurality of” means two or more unless otherwise specified.

In the description of some embodiments, the expressions “connected” and derivatives thereof may be used. The term “connection” should be understood in a broad sense. For example, the “connection” may be a fixed connection, a detachable connection, or of an integrated structure; it may be a direct connection or an indirect connection by an intermediate medium. The embodiments disclosed herein are not necessarily limited to the content herein.

The phrase “at least one of A, B and C” has a same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

The phrase “applicable to” or “configured to” as used herein indicates an open and inclusive expression, which does not exclude devices that are applicable to or configured to perform additional tasks or steps.

The term “about” as used herein includes a stated value and an average value within an acceptable range of deviation of a particular value. The acceptable range of deviation is determined by a person of ordinary skill in the art in consideration of the measurement in question and errors associated with the measurement of a particular quantity (i.e., limitations of the measurement system).

The term such as “parallel”, “perpendicular” or “equal” as used herein includes a stated condition and a condition similar to the stated condition. A range of the similar condition is within an acceptable range of deviation. The acceptable range of deviation is determined by a person of ordinary skill in the art in view of measurement in question and errors associated with the measurement of a particular quantity (i.e., limitations of the measurement system). For example, the term “parallel” includes absolute parallelism and approximate parallelism, and an acceptable range of deviation of the approximate parallelism may be a deviation within 5°; the term “perpendicular” includes absolute perpendicularity and approximate perpendicularity, and an acceptable range of deviation of the approximate perpendicularity may also be a deviation within 5°; and the term “equal” includes absolute equality and approximate equality, and an acceptable range of deviation of the approximate equality may be a difference between two equals being less than or equal to 5% of either of the two equals.

It will be understood that when a layer or element is referred to as being on another layer or substrate, the layer or element may be directly on the another layer or substrate, or there may be intermediate layer(s) between the layer or element and the another layer or substrate.

Exemplary embodiments are described herein with reference to sectional views and/or plane views as idealized exemplary drawings. In the accompanying drawings, thicknesses of layers and sizes of areas/regions are enlarged for clarity. Variations in shapes relative to the accompanying drawings due to, for example, manufacturing technologies and/or tolerances may be envisaged. Therefore, the exemplary embodiments should not be construed to be limited to the shapes of areas/regions shown herein, but to include deviations in the shapes due to, for example, manufacturing. For example, an etched area/region shown in a rectangular shape generally has a feature of being curved. Therefore, the areas/regions shown in the accompanying drawings are schematic in nature, and their shapes are not intended to show actual shapes of the areas/regions in a device, and are not intended to limit the scope of the exemplary embodiments.

The directional terms such as “up”, “down”, “left” and “right” as described in the embodiments herein are described from a perspective shown in the accompanying drawings and should not be understood as limitations on the embodiments of the present disclosure.

In the related art, the method for manufacturing the dimming panel is as follows: a plurality of dye liquid crystal layers corresponding to a plurality of frame sealants are formed on a second substrate motherboard; a first substrate motherboard and the second substrate motherboard are then aligned together to form a dimming panel motherboard; and finally the dimming panel motherboard is cut along an edge of each frame sealant to obtain a dimming panel. During manufacturing the dimming panel motherboard, various specifications of dimming panels result in inconsistent shapes and perimeters of the frame sealants. Therefore, during manufacturing the dimming panel motherboard, it is necessary to frequently switch the parameters of the frame sealants in the coating equipment, resulting in waste of production capacity of the coating equipment. In a case of producing relatively small dimming panels, the frame sealants in the dimming panel motherboard have a relatively long total of perimeters, which further lead to a decrease in speed of the entire production line, resulting in a relatively low production capacity of the production line. In addition, during manufacturing the dimming panels, considering a product qualification rate, the number of products actually produced is greater than the number of the required products, and the excess dimming panels need to be stored in the warehouse. Only when the dimming panels of the same specifications are produced again can the dimming panels in the warehouse be reused, which further leads to a large amount of inventory in the warehouse and a long inventory cycle.

In order to solve the above problems, embodiments of the present disclosure provide a method for manufacturing a dimming panel 100, and the manufacturing method includes the following steps S100 to S400.

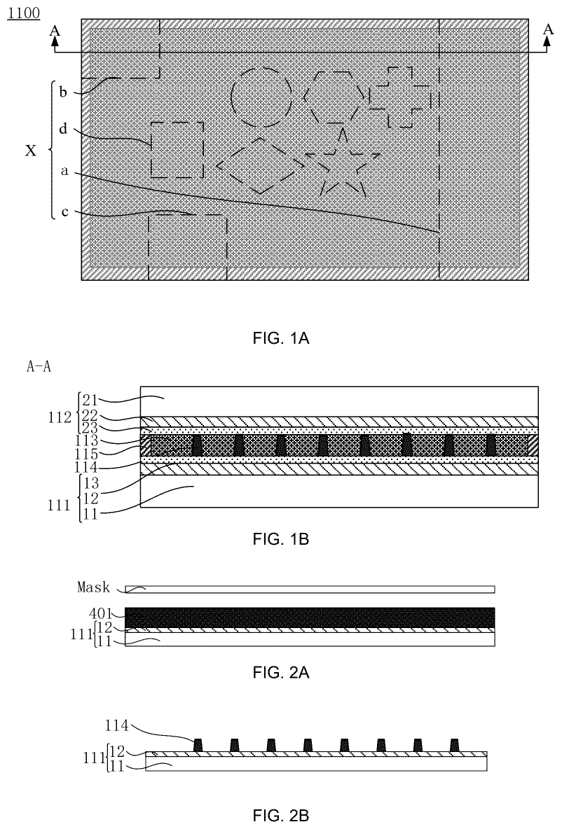

In S100, as shown in FIG. 1A, a dimming panel motherboard 1100 is formed.

FIG. 1B is a cross-sectional view taken along a section line A-A in FIG. 1A. As shown in FIG. 1B, the dimming panel motherboard 1100 includes a first substrate motherboard 111, a second substrate motherboard 112, a dye liquid crystal layer 113, a plurality of spacers 114 and a frame sealant 115.

As shown in FIG. 1B, the first substrate motherboard 111 and the second substrate motherboard 112 are disposed opposite to each other. The first substrate motherboard 111 includes a first base 11, a first electrode layer 12 and a first alignment layer 13. The first electrode layer 12 is located on a side of the first base 11 proximate to the second substrate motherboard 112, and the first electrode layer 12 covers the first base 11. The first alignment layer 13 is located on a side of the first electrode layer away from the first base 11. The second substrate motherboard 112 includes a second base 21, a second electrode layer 22 and a second alignment layer 23. The second electrode layer 22 is located on a side of the second base 21 proximate to the first substrate motherboard 111, and the second electrode layer 22 covers the second base 21. The second alignment layer 23 is located on a side of the second electrode layer 23 away from the second base 21. The materials of the first base 11 and the second base 21 may include materials with high light transmittance (e.g., light transmittance greater than 85%). The materials of the first base 11 and the second base 21 may include glass or plastic. The first base 11 and the second base 21 may include one or more of polyethersulfone (PES), polyarylate (PAR), polyetherimide (PEI), polyethylene naphthalate (PEN), polyethylene terephthalate (PET), polyphenylene sulfide (PPS), polyimide (PI), polycarbonate (PC), tri-cellulose acetate (TCA), cellulose acetate propionate (CAP), polyphenylene sulfone resin (PPSU), cycloolefin polymer (COP) and polymethyl methacrylate (PMMA). For example, the materials of the first base 11 and the second base 21 are polyimide. The materials of the first electrode layer 12 and the second electrode layer 22 include a conductive material with high light transmittance. For example, the materials of the first electrode layer 12 and the second electrode layer 22 include indium tin oxide (ITO). The materials of the first alignment layer 13 and the second alignment layer 23 include polyimide.

As shown in FIG. 1B, the dye liquid crystal layer 113 is located between the first substrate motherboard 111 and the second substrate motherboard 112. That is, the first electrode layer 12 is located on a side of the first base 11 proximate to the dye liquid crystal layer 113, and the second electrode layer 22 is located on a side of the second base 21 proximate to the dye liquid crystal layer 113. The dye liquid crystal layer 113 includes dye molecules and liquid crystal molecules. The first alignment layer 13 and the second alignment layer 23 are used to align liquid crystal molecules in a certain direction and angle. That is, the first alignment layer 13 and the second alignment layer 23 can align the liquid crystal molecules according to a set pre-tilt angle. The angles formed between the long axis directions of the dye molecules and the first base 11 are different, and the amounts of light absorbed by the dye molecules are also different. By changing a voltage value between the first electrode layer 12 and the second electrode layer 22, the angles formed between the long axis directions of the liquid crystal molecules and the first base 11 may be changed, that is, the angle formed between the long axis directions of the dye molecules and the first base 11 may be changed, so as to change the amount of light absorbed by the dye molecules, thereby adjusting the transmittance of the dye liquid crystal layer 113 and the transmittance of the dimming panel 100.

As shown in FIG. 1B, the plurality of spacers 114 are distributed in an array. A distance between two adjacent spacers 114 is in a range of 0.2 mm to 1 mm, inclusive. For example, the distance between the two adjacent spacers 114 is 0.2 mm, 0.5 mm, or 1 mm, which are not listed one by one in the embodiments of the present disclosure. A height of the spacer 114 is in a range of 5 μm to 30 μm, inclusive. For example, the height of the spacer 114 is 5 μm, 8 μm, 12 μm, 15 μm, 18 μm, 20 μm, 25 μm or 30 μm, which are not listed one by one in the embodiments of the present disclosure. For example, the spacer 114 is in a shape of a truncated cone, that is, a longitudinal cross-section of the spacer 114 is trapezoidal, and a diameter of the spacer 114 is in a range of 5 μm to 25 μm, inclusive. For example, the diameter of the spacer 114 is 5 μm, 15 μm or 25 μm, which are not listed one by one in the embodiments of the present disclosure.

As shown in FIG. 1B, the frame sealant 115 is located between the first substrate motherboard 111 and the second substrate motherboard 112 and surrounds the dye liquid crystal layer 113. The frame sealant 115 may be made of sealing adhesive. In the embodiments of the present disclosure, the dimming panel motherboard 1100 is provided with the frame sealant 115 only at the edge, and no frame sealant 115 is provided inside the dimming panel motherboard 1100.

In some embodiments, S100 includes S110 to S140.

In S110, as shown in FIG. 2A, an initial support layer 401 is formed on the first substrate motherboard 111.

For example, the first substrate motherboard 111 is coated with a support material in a roll-to-roll slit manner or a micro-dimple manner, and a thickness of the coat material is in a range of 30 μm to 100 μm, inclusive. The coat material is pre-cured to form the initial support layer 401. A heating temperature for pre-curing is in a range of 90 °C to 120 °C, inclusive, a heating time is in a range of 80 s to 150 s, inclusive, and a thickness of the initial support layer 401 after pre-curing is in a range of 5 μm to 30 μm, inclusive.

In S120, as shown in FIG. 2A, direct-write exposure is performed on the initial support layer 401 using a digital mask Mask.

Laser may be used to perform direct-write exposure on the initial support layer 401.

In S130, as shown in FIG. 2B, developing, cleaning and curing are performed on the initial support layer 401 to form the plurality of spacers 114.

For example, a development time is in a range of 120 s to 300 s, inclusive. The height of the spacer 114, the distance between the spacers 114 and the diameter of the spacer 114 are as described above and will not be repeated here.

In S140, as shown in FIG. 1B, the first substrate motherboard 111 and the second substrate motherboard 112 are aligned together to form the dimming panel motherboard 1100.

In the embodiments of the present disclosure, the initial support layer 401 is exposed using the laser and the digital mask. The laser has good straightness, which may ensure substantially the same exposure amount of the initial support layer 401 in a direction perpendicular to the first substrate motherboard 111. An included angle between a sidewall of the spacer 141 and the first substrate motherboard 111 is greater than 80°, and/or a diameter of an end of the spacer 141 away from the first substrate motherboard 111 is greater than a product of a diameter of an end of the spacer 141 proximate to the first substrate motherboard 111 and 0.9. In this way, in the direction perpendicular to the first substrate motherboard 111 and pointing from the first substrate motherboard 111 to the second substrate motherboard 112, a cross-section of the spacer 114 parallel to the first substrate motherboard 111 has a small difference in area, resulting in a relatively small contact stress and a relatively small maximum shear stress between the second substrate motherboard 112 and the spacer 114, thereby reducing a risk of a short life of the second substrate motherboard 112 caused by cracks in the second substrate motherboard 112. The laser has good straightness and may be directly used in the digital mask without complicated processing, thereby reducing the manufacturing cost of the dimming panel motherboard 1100.

In S200, the dimming panel motherboard 1100 is cut to form an initial dimming panel 220.

Since the dye liquid crystal has fluidity, in order to reduce loss of the dye liquid crystal, the following method may be used to form the initial dimming panel 220.

In some embodiments, S200 includes S210 and S220.

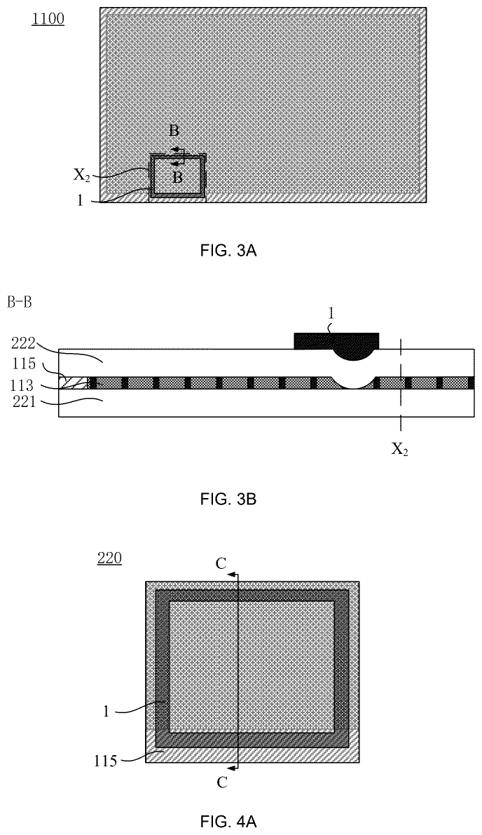

In S210, as shown in FIGS. 3A and 3B, the dimming panel motherboard 1100 is pressed using a holddown 1.

As shown in FIG. 3B, a holddown 1 is placed on the dimming panel motherboard 1100, and a force is applied to the holddown 1, so that the first substrate motherboard 111 and the second substrate motherboard 112 are in contact at the holddown 1.

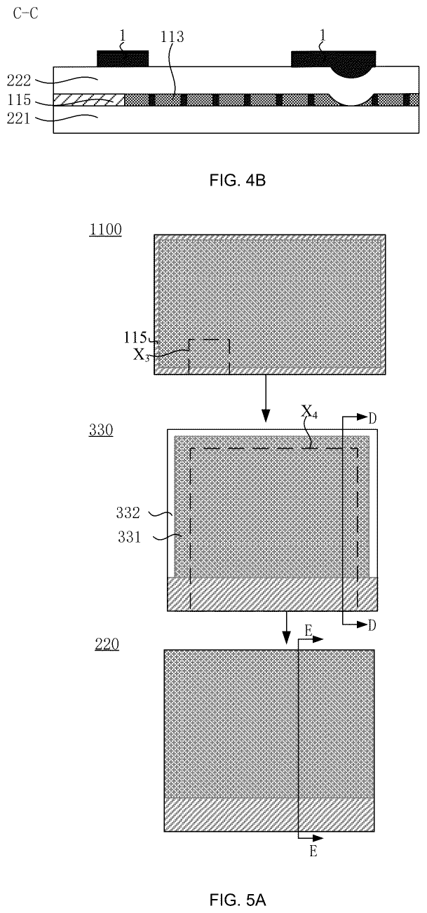

In S220, as shown in FIGS. 3A and 4B, the dimming panel motherboard 1100 is cut along a second cutting line X₂ to form the initial dimming panel 220.

FIG. 4B is a cross-sectional view taken along a section line C-C in FIG. 4A. As shown in FIG. 4B, the initial dimming panel 220 includes a first transition plate 221 and a second transition plate 222. An orthographic projection of the second transition plate 222 on a reference plane coincides with an orthographic projection of the first transition plate 221 on the reference plane. At least part of a sidewall of the first transition plate 221 is flush with at least part of a sidewall of the dye liquid crystal layer 113. The first transition plate 221 is flush with at least part of the dye liquid crystal layer 113. The initial dimming panel 220 may be in a circular, triangular, rectangular or irregular shape. The reference plane is parallel to a surface of the first transition plate 221 proximate to the dye liquid crystal layer 113.

The first transition plate 221 and the second transition plate 222 are in contact at the holddown 1, so as to isolate the dye liquid crystal layer 113 inside the contact position of the first transition plate 221 and the second transition plate 222 from the atmosphere, thereby reducing a risk of air intruding into the dye liquid crystal layer 113 and maintaining a vacuum state of the dye liquid crystal layer 113.

In some other embodiments, S200 includes S230 and S240.

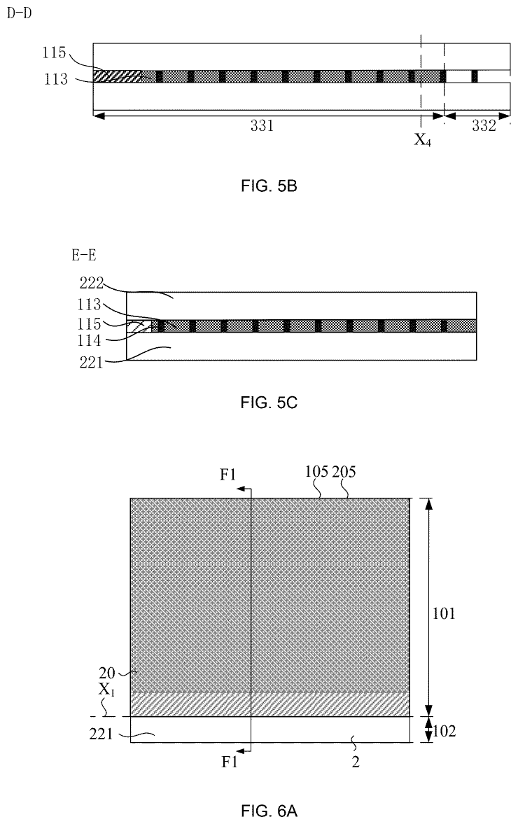

In S230, as shown in FIG. 5A, the dimming panel motherboard 1100 is cut along a third cutting line X₃ to form a first dimming panel 330.

As shown in FIG. 5B, the first dimming panel 330 has a panel region 331 and a liquid leakage region 332. In the liquid leakage region 332, there is no dye liquid crystal layer 113 and frame sealant 115 between the first substrate motherboard 111 and the second substrate motherboard 112. As shown in FIG. 5A, the liquid leakage region 332 surrounds the panel region 331 and extends along the third cutting line X₃. The dye liquid crystal layer 113 of the first dimming panel 330 is exposed to the air, and the air will invade the dye liquid crystal layer 113. The dye liquid crystal is fluid, and the dye liquid crystal at an edge of the first dimming panel 330 will flow away. Since the dye liquid crystal is sticky, after a certain amount of the dye liquid crystal at the edge has flowed away, the pressure of the dye liquid crystal layer 113 is equal to the pressure of the air, and the dye liquid crystal will no longer flow away. The region where the dye liquid crystal has flowed away is the liquid leakage region 332, and the remaining region is the panel region 331.

In S240, as shown in FIG. 5A, the first dimming panel 330 is cut along a fourth cutting line X₄ to form the initial dimming panel 220.

As shown in FIG. 5C, the initial dimming panel 220 includes a first transition plate 221 and a second transition plate 222. An orthographic projection of the second transition plate 222 on a reference plane coincides with an orthographic projection of the first transition plate 221 on the reference plane. At least part of a sidewall of the first transition plate 221 is flush with at least part of a sidewall of the dye liquid crystal layer 113. The first transition plate 221 is flush with at least part of the dye liquid crystal layer 113. As shown in FIG. 5A, the fourth cutting line X₄ is located in the panel region 331. In S230, the pressure of the dye liquid crystal layer 113 is equal to the pressure of the air, that is, the pressure of the dye liquid crystal layer 113 and the pressure of the air have reached equilibrium. During cutting the first dimming panel 330 along the fourth cutting line X₄ to form the initial dimming panel 220, the dye liquid crystal layer 113 will no longer leak.

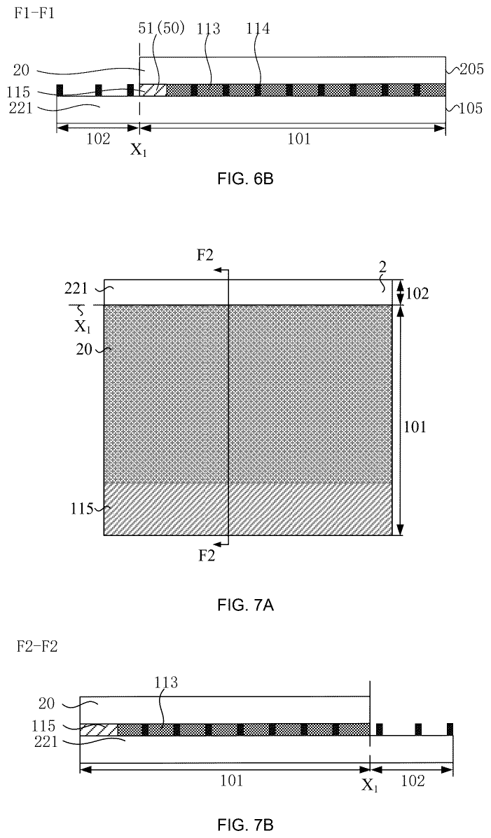

In S300, as shown in FIGS. 6A, 6B, 7A and 7B, the second transition plate 222 is cut along a first cutting line X₁ to form a second substrate 20.

The second substrate 20 exposes a first region 2 of the first transition plate 221, and the first region 2 forms a first bonding region 102. The remaining region of the first transition plate 221 forms a first main body region 101, and the first bonding region 102 is located on a side of the first main body region 101. For example, as shown in FIG. 6A, the first bonding region 102 is located on a lower side of the first main body region 101. Alternatively, as shown in FIG. 7A, the first bonding region 102 is located on an upper side of the first main body region 101.

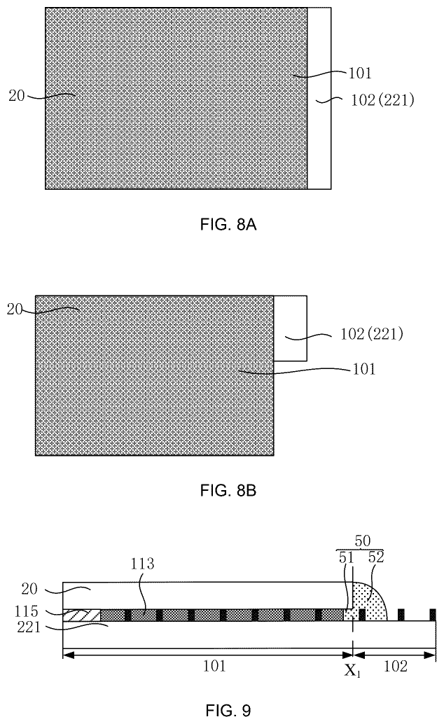

In addition, a size and a shape of the first bonding region 102 may be set depending on actual conditions. For example, as shown in FIG. 8A, the shape of the first bonding region 102 is rectangular, and a dimension of the first bonding region 102 in a width direction of the first transition plate 221 is equal to a width of the first transition plate 221. As another example, as shown in FIG. 8B, a dimension of the first bonding region 102 in the width direction of the first transition plate 221 is smaller than the width of the first transition plate 221. The dye liquid crystal layer 113 is located between the first transition plate 221 and the second substrate 20.

In some embodiments, as shown in FIGS. 7A and 7B, an orthographic projection of the first cutting line X₁ on the reference plane is located within an orthographic projection of the frame sealant 115 on the reference plane. A portion of the second transition plate 222 located on a side of the first cutting line X₁ away from the dye liquid crystal layer 113 is removed along the first cutting line X₁ to form the second substrate 20. During forming the second substrate 20, any part of the dye liquid crystal layer 113 will not be removed, so as to maximize a region of the dye liquid crystal layer 113, and thus the formed dimming panel 100 may have a relatively large dimming region. The dimming region refers to a region of the dimming panel 100 where the transmittance can be adjusted.

In some other embodiments, as shown in FIG. 9, an orthographic projection of the first cutting line X₁ on the reference plane is located within an orthographic projection of the dye liquid crystal layer 113 on the reference plane. A portion of the second transition plate 222 in contact with the dye liquid crystal layer 113 is removed along the first cutting line X₁ to form the second substrate 20.

In some embodiments, as shown in FIG. 1A, the dimming panel motherboard 1100 may be cut along different cutting lines X depending on actual needs. FIG. 1A shows a structural diagram of shapes of the cutting lines X.

In some embodiments, the cutting line X includes a cutting line a, and the cutting line a intersects two opposite sides. That is, the initial dimming panel 220 obtained along the cutting line a includes the frame sealant 115 at three sides.

In some other embodiments, the cutting line X is located at a corner of the dimming panel motherboard 1100, that is, the cutting line X includes a cutting line b, and the cutting line b intersects with two adjacent sides. That is, the initial dimming panel 220 obtained along the cutting line X includes the frame sealant at two adjacent sides.

In some other embodiments, the cutting line X is located at an edge of the dimming panel motherboard 1100 and does not pass through a corner of the dimming panel motherboard 1100. The cutting line X includes a cutting line c, and the cutting line c intersects a side. That is, the initial dimming panel 220 obtained along the cutting line c includes the frame sealant at one side.

In some other embodiments, the cutting line X is located inside the dimming panel motherboard 1100, the cutting line X includes a cutting line d, and the cutting line d does not intersect a side. That is, the initial dimming panel 220 obtained along the cutting line d does not include the frame sealant. The shape enclosed by the cutting line X is a circle, a rectangle, a diamond, a five-pointed star or a cross, which are listed one by one in the embodiments of the present disclosure.

When the dimming panel motherboard 1100 is cut, the shapes of the four cutting lines X may be reasonably combined to maximize the utilization of the dimming panel motherboard 1100. The embodiments of the present disclosure are described by taking an example in which the cutting line X is the cutting line c.

The dimming panel motherboard 1100 may be cut using different cutting tools depending on the material of the first base 11. In a case where the first base 11 and the second base 21 are made of hard materials, the dimming panel motherboard 1100 may be cut using a cutting wheel. In a case where the first base 11 and the second base 21 are made of flexible materials, the dimming panel motherboard 1100 may be cut using a laser or a mold cutter head.

In some embodiments, as shown in FIGS. 10A and 10B, in a case where the manufacturing method includes the holddown 1, in a process of cutting the second transition plate 222 to form the second substrate 20 in S300, the second transition plate 222 is also cut along an outer edge of the holddown 1. The second substrate 20 further exposes a third region 4 of the second transition plate 222, and a width of the third region 4 is smaller than a width of the first region 2. The second substrate 20 has a second sidewall 203, and the first transition plate 221 has a first sidewall 103. The second sidewall 203 is substantially parallel to the first sidewall 103, and an orthographic projection of the second sidewall 203 on the first transition plate 221 (which is used for forming a first substrate 10) and the first sidewall 103 have a gap therebetween.

In some other embodiments, as shown in FIGS. 11A and 11B, in a case where the manufacturing method includes the holddown 1, in a process of cutting the second transition plate 222 to form the second substrate 20 in S300, the first transition plate 221 has a third sidewall 104, and the second substrate 20 has a fourth sidewall 204. The third sidewall 104 is substantially parallel to the fourth sidewall 204, and an orthographic projection of the third sidewall 104 on the reference plane coincides with an orthographic projection of the fourth sidewall 204 on the reference plane.

In some other embodiments, as shown in FIGS. 6A and 6B, in a process of cutting the second transition plate 222 to form the second substrate 20 in S300, the first transition plate 221 has a fifth sidewall 105, and the second substrate 20 has a sixth sidewall 205. The fifth sidewall 105 is substantially parallel to the sixth sidewall 205, and orthographic projections of the fifth sidewall 105 and the sixth sidewall 205 on the reference plane and an orthographic projection of the dye liquid crystal layer 113 on the reference plane coincide with each other.

In S400, as shown in FIGS. 6A, 6B and 9, the first edge sealant 50 is formed along the first cutting line X₁.

In some embodiments, as shown in FIGS. 6A and 6B, the first edge sealant 50 includes a first sub-portion 51. The first sub-portion 51 is located between the first transition plate 221 and the second substrate 20 and is disposed along an edge of the second substrate 20 proximate to the first bonding region 102.

In a case where the orthographic projection of the first cutting line X₁ on the reference plane is located within the orthographic projection of the frame sealant 115 on the reference plane, in a process of cutting the second transition plate 222 along the first cutting line X₁ to form the second substrate 20 in S300, a portion of the frame sealant 115 located on a side of the first cutting line X₁ away from the dye liquid crystal layer 113 is removed along the first cutting line X₁, and a portion of the frame sealant 115 located between the first cutting line X₁ and the dye liquid crystal layer 113 forms the first sub-portion 51. The first edge sealant 50 is formed by using the frame sealant 115 of the dimming panel motherboard 1100 without additional glue for forming the first edge sealant 50. This may reduce the manufacturing cost of the dimming panel 100.

In some other embodiments, as shown in FIG. 9, the first edge sealant 50 includes a first sub-portion 51 and a second sub-portion 52. The first sub-portion 51 is located between the first transition plate 221 and the second substrate 20 and is disposed along an edge of the second substrate 20 proximate to the first bonding region 102. The second sub-portion 52 is disposed along an edge of the first bonding region 102 proximate to the second substrate 20, and the second sub-portion 52 is also bonded to a sidewall of the second substrate 20 proximate to the first bonding region 102. The second sub-portion 52 wraps the sidewall of the second substrate 20 proximate to the first bonding region 102, that is, the second sub-portion 52 isolates the sidewall of the second substrate 20 proximate to the first bonding region 102 from the air, which may reduce a risk of moisture invading the dimming panel 100 from the sidewall of the second substrate 20 proximate to the first bonding region 102, so as to reduce a risk of material aging of the dimming panel 100, thereby prolonging a service life.

In a case where the orthographic projection of the first cutting line X₁ on the reference plane is located within the orthographic projection of the dye liquid crystal layer 113 on the reference plane, glue is applied to the first bonding region 102, and a portion of the glue between the dye liquid crystal layer 113 and the first cutting line X₁ forms the first sub-portion 51. The first edge sealant 50 further includes a second sub-portion 52, and a portion of the glue located in the first bonding region 102 and extending along the sidewall of the second substrate 20 proximate to the first bonding region 102 forms the second sub-portion 52.

The material of the first edge sealant 50 may be the same as the material of the frame sealant 115. For example, the materials of the first edge sealant 50 and the frame sealant 115 include sealing adhesive. Alternatively, the material of the first edge sealant 50 may be different from the material of the frame sealant. For example, the material of the frame sealant 115 is sealing adhesive, and the material of the first edge sealant 50 is UV adhesive.

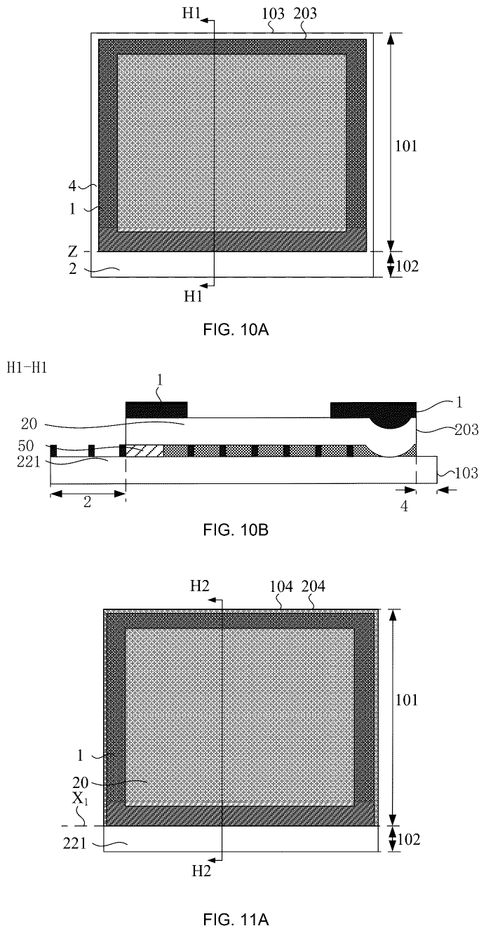

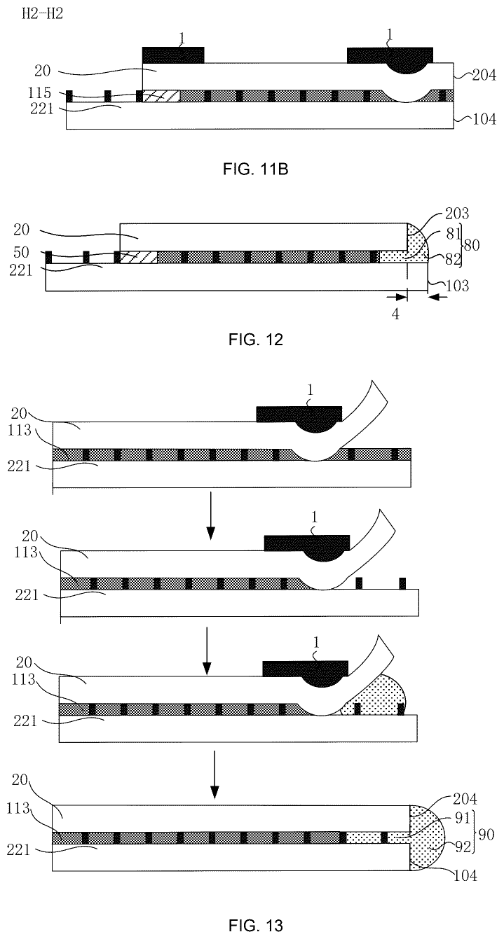

In some embodiments, as shown in FIG. 12, in a case where the second substrate 20 has a second sidewall 203 and the first transition plate 221 has a first sidewall 103, a second edge sealant 80 is further formed during formation of the first edge sealant 50. The second edge sealant 80 includes a third sub-portion 81 and a fourth sub-portion 82. The third sub-portion 81 is located between the first substrate 10 and the second substrate 20 and is disposed along an edge of the second substrate 20 proximate to the second sidewall 203. The third sub-portion 81 is used to isolate the dye liquid crystal and the air.

The fourth sub-portion 82 is disposed along the second sidewall 203 and is bonded to the second sidewall 203. In this way, the fourth sub-portion 82 wraps the second sidewall 203, that is, the fourth sub-portion 82 isolates the second sidewall 203 from the air, which may reduce a risk of moisture invading the dimming panel 100 from the second sidewall 203, so as to reduce the risk of the material aging of the dimming panel 100. The fourth sub-portion 82 is connected to a sidewall of the third sub-portion 81 proximate to the fourth sub-portion 82.

The fourth sub-portion 82 further covers the third region 4. In this way, the fourth sub-portion 82 isolates the first transition plate 221 located in the third region 4 from the air, thereby reducing the risk of moisture corroding the first transition plate 221.

For example, the second edge sealant 80 may be formed by the following method. The dye liquid crystal in the third region 4 is removed using a dust-free cloth or plasma, and glue is applied to the third region 4, where a portion of the glue located between the dye liquid crystal layer 113 and the second sidewall 203 forms the third sub-portion 81, and another portion of the glue located in the third region 4 and extending along the second sidewall 203 forms the fourth sub-portion 82. The third region 4 only has the first transition plate 221, that is, there is no second substrate 20 above the first transition plate 221, which may make it easy to clean the dye liquid crystal and apply the glue.

In some other embodiments, as shown in FIG. 13, in a case where the first transition plate 221 has a third sidewall 104 and the second substrate 20 has a fourth sidewall 204, a third edge sealant 90 is further formed during formation of the first edge sealant 50.

The third edge sealant 90 includes a fifth sub-portion 91 and a sixth sub-portion 92. The fifth sub-portion 91 is located between the first substrate 10 and the second substrate 20, and is disposed along an edge of the first substrate 10 proximate to the third sidewall 104. The fifth sub-portion 91 is used to isolate the dye liquid crystal and the air. The sixth sub-portion 92 is disposed along the third sidewall 104 and bonded to the third sidewall 104. The sixth sub-portion 92 wraps the third sidewall 104, that is, the sixth sub-portion 92 isolates the third sidewall 104 from the air, which may reduce the risk of the material aging of the dimming panel 100. The sixth sub-portion 92 is disposed along the fourth sidewall 204 and bonded to the fourth sidewall 204. The sixth sub-portion 92 wraps the fourth sidewall 204, that is, the sixth sub-portion 92 isolates the fourth sidewall 204 from the air, which may reduce the risk of the material aging of the dimming panel 100. The sixth sub-portion 92 is also connected to a sidewall of the fifth sub-portion 91 proximate to the third sidewall 104.

For example, as shown in FIG. 13, the third edge sealant 90 may be formed by the following method. First, a force is applied to a portion of the second substrate 20 located between the holddown 1 and an edge of the second substrate 20, so that the portion of the second substrate 20 located between the holddown and the edge of the second substrate 20 is bent towards a direction away from the first transition plate 221, so as to obtain a large cleaning space. Then, the dye liquid crystal located between the holddown and the edge of the first transition plate 221 is cleaned using a dust-free cloth or plasma, and then glue is applied to the region where the dye liquid crystal is cleaned. Finally, a force is applied to the portion of the second substrate 20 located between the holddown 1 and the edge of the second substrate 20, so that the portion of the second substrate 20 located between the holddown 1 and the edge of the second substrate 20 is bent towards a direction approaching the first substrate 10. As a result, the first transition plate 221 and the second substrate 20 are capable of squeezing the glue to form the third edge sealant 90. A portion of the glue located between the dye liquid crystal layer 113 and the third sidewall 104 forms the fifth sub-portion 91, and another portion of the glue extending along the third sidewall 104 and the fourth sidewall 204 forms the sixth sub-portion 92.

Alternatively, the third edge sealant 90 only includes the fifth sub-portion 91. The fifth sub-portion 91 is located between the first substrate 10 and the second substrate 20, and is disposed along an edge of the first substrate 10 proximate to the third sidewall 104. The fifth sub-portion 91 is used to isolate the dye liquid crystal from the air.

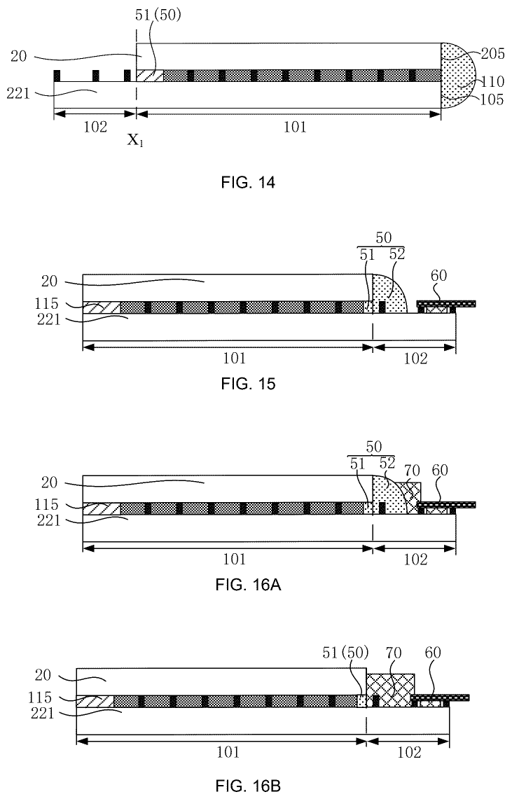

In some other embodiments, as shown in FIG. 14, in a case where the first transition plate 221 has a fifth sidewall 105 and the second substrate 20 has a sixth sidewall 205, a fourth edge sealant 110 is further formed during formation of the first edge sealant 50. The fourth edge sealant 110 is disposed along the fifth sidewall 105, the sixth sidewall 205 and an edge of the dye liquid crystal layer 113 proximate to the fifth sidewall 105.

The fourth edge sealant 110 is bonded to the fifth sidewall 105, and the fourth edge sealant 110 wraps the fifth sidewall 105, that is, the fourth edge sealant 110 isolates the fifth sidewall 105 from the air, which may reduce the risk of moisture invading the dimming panel 100 from the fifth sidewall 105 and reduce the risk of the material aging of the dimming panel 100. The fourth edge sealant 110 is bonded to the sixth sidewall 205, and the fourth edge sealant 110 wraps the sixth sidewall 205, that is, the fourth edge sealant 110 isolates the sixth sidewall 205 from the air, which may reduce the risk of moisture invading the dimming panel 100 from the sixth sidewall 205 and reduce the risk of the material aging of the dimming panel 100.

For example, the fourth edge sealant 110 may be formed by the following methods. For example, the fifth sidewall 105 and the sixth sidewall 205 are placed below a liquid surface of glue, and due to the action of a surface tension of the glue, the glue will wrap the fifth sidewall 105, the sixth sidewall 205 and part of the sidewall of the dye liquid crystal layer 113 to form the fourth edge sealant 110. As another example, glue is applied to the fifth sidewall 105, the sixth sidewall 205 and the edge of the dye liquid crystal layer 113 proximate to the fifth sidewall 105 to form the fourth edge sealant 110.

The frame sealants 115 in the dimming panel motherboard 1100 provided in the embodiments of the present disclosure have consistent sizes and shapes. During forming the frame sealant 115, the time for the coating equipment to form the frame sealant 115 is consistent, and there is no need to frequently switch the parameters of the frame sealants in the coating equipment and reduce the speed of the production line. When dimming panels 100 of any specification are produced again, the dimming panel motherboards 1100 in the warehouse may be reused, which may reduce the inventory in the warehouse, that is, shorten the inventory cycle.

In some embodiments, after forming the first edge sealant 50 along the first cutting line X₁ in S400, the manufacturing method further includes S500 and S600.

In S500, as shown in FIG. 15, a first circuit board 60 is bonded to the first bonding region 102 of the first transition plate 221.

There is a gap between the first circuit board 60 and the first edge sealant 50. For example, the first circuit board 60 and the first transition plate 221 are bonded together using anisotropic conductive adhesive.

In S600, a first protective adhesive 70 is formed between the first circuit board 60 and the first edge sealant 50.

As shown in FIG. 16A, in a case where the first edge sealant 50 includes the first sub-portion 51 and the second sub-portion 52, the first protective adhesive 70 is bonded to the first edge sealant 50 and the first circuit board 60. The first protective adhesive 70 may enhance the firmness of the first circuit board 60 and the first electrode layer 12. The first protective adhesive 70 further covers a second region, and a region of the first bonding region 102 exposed by the first circuit board 60 and the first edge sealant 50 forms the second region. That is, a region formed by orthographic projections of the first edge sealant 50, the first protective adhesive 70 and the first circuit board 60 on the first substrate 10 covers the first bonding region 102. In this way, the first edge sealant 50, the first protective adhesive 70 and the first circuit board 60 work together to isolate the first transition plate 221 located in the first bonding region 102 from the air, thereby reducing the risk of oxidation of the first transition plate 221 located in the first bonding region 102. A material of the first protective adhesive 70 includes ultraviolet adhesive.

As shown in FIG. 16B, in a case where the first edge sealant 50 only includes the first sub-portion 51, the difference from the above is that the first protective adhesive 70 is bonded to a sidewall of the second substrate 20 proximate to the first bonding region 102. In this way, the first protective adhesive 70 wraps the sidewall of the second substrate 20 proximate to the first bonding region 102, that is, the first protective adhesive 70 isolates the sidewall of the second substrate 20 proximate to the first bonding region 102 from the air, thereby reducing the risk of moisture invading the dimming panel 100 from the sidewall of the second substrate 20 proximate to the first bonding region 102, and reducing the risk of the material aging of the dimming panel 100.

The embodiments of the present disclosure further provide a dimming panel 100. The dimming panel 100 includes a polymer dispersed liquid crystal (PDLC) dimming panel 100, an electrochromic (EC) dimming panel 100, a dye liquid crystal dimming panel 100, or a suspended particle device (SPD) dimming panel 100. The embodiments of the present disclosure are described by considering an example where the dimming panel 100 is the dye liquid crystal dimming panel 100.

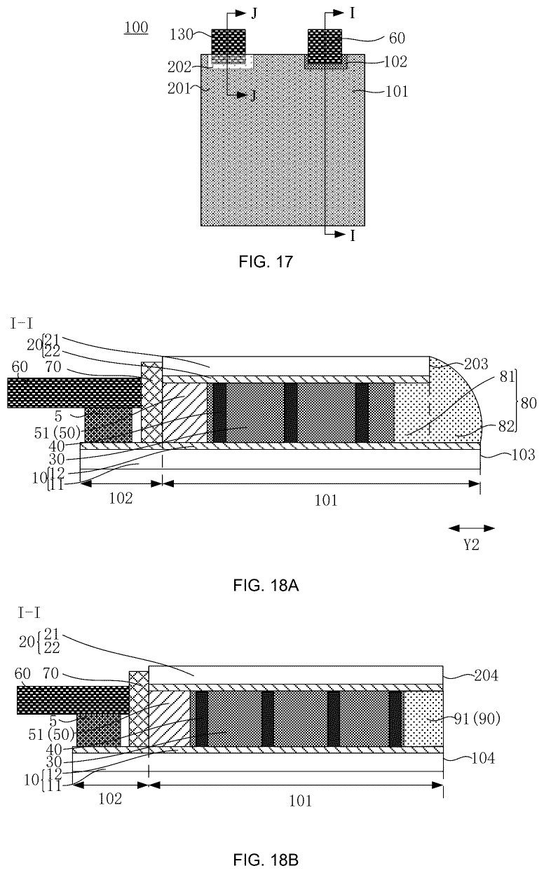

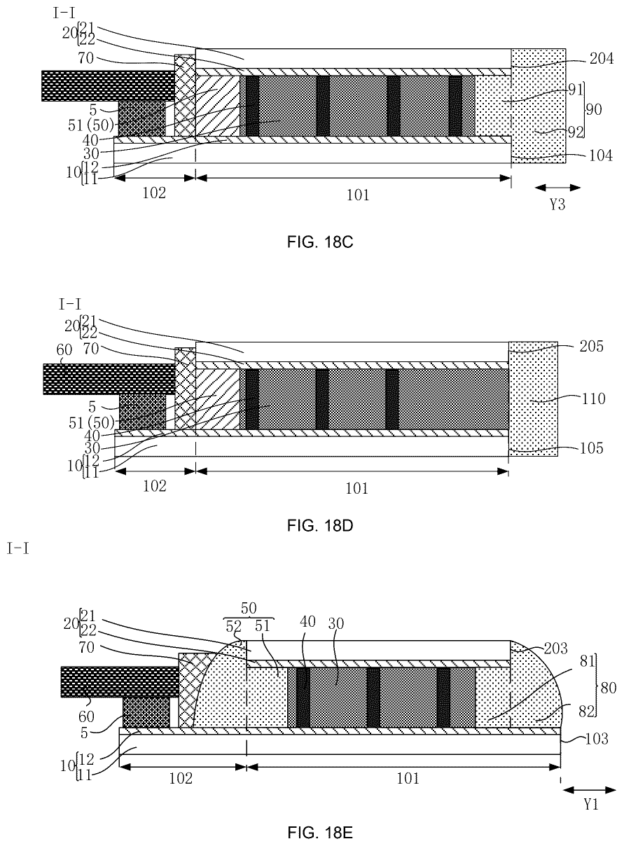

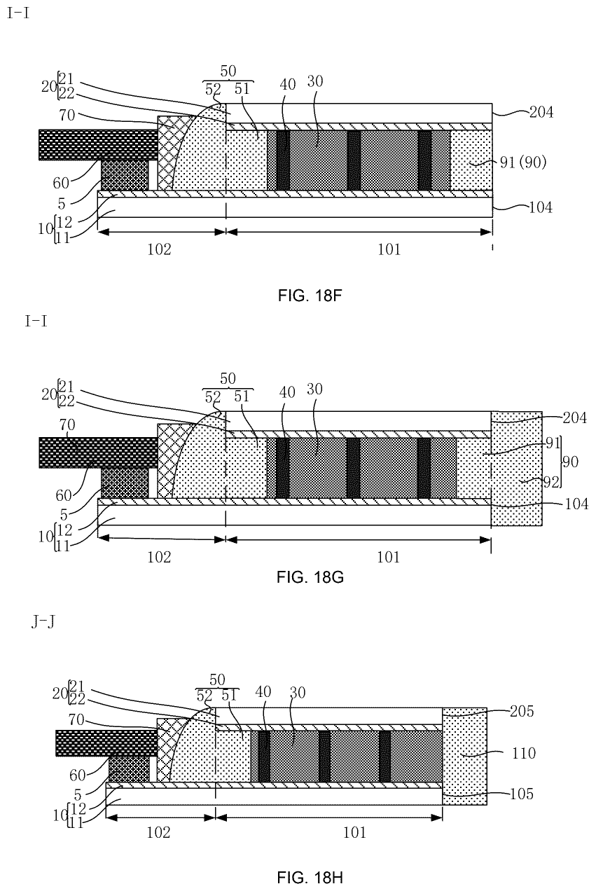

In some embodiments, as shown in FIGS. 17 and 18A to 18H, the dimming panel 100 includes a first substrate 10, a second substrate 20, a dye liquid crystal layer 30, a plurality of spacers 40 and a first edge sealant 50.

As shown in FIGS. 18A to 18H, the first substrate 10 and the second substrate 20 are provided opposite to each other. The first substrate 10 includes a first base 11 and a first electrode layer 12. The material of the first base 11 may include a material with high light transmittance (e.g., light transmittance greater than 85%). The material of the first base 11 may include glass or plastic. The first base 11 may include one or more of polyethersulfone (PES), polyarylate (PAR), polyetherimide (PEI), polyethylene naphthalate (PEN), polyethylene terephthalate (PET), polyphenylene sulfide (PPS), polyimide (PI), polycarbonate (PC), tri-cellulose acetate (TCA), cellulose acetate propionate (CAP), polyphenylene sulfone resin (PPSU), cycloolefin polymer (COP) and polymethyl methacrylate (PMMA). For example, the material of the first base 11 is polyimide.

The first electrode layer 12 is located on a side of the first base 11 proximate to the second substrate 20. The first electrode layer 12 covers the first base 11. The material of the first electrode layer 12 includes a conductive material with high light transmittance. For example, the material of the first electrode layer 12 includes indium tin oxide (ITO).

The first substrate 10 has a first main body region 101 and a first bonding region 102. The first bonding region 102 is located on a side of the first main body region 101. An orthographic projection of the second substrate 20 on the first substrate 10 is located within the first main body region 101 and does not overlap with the first bonding region 102. The sizes and the shapes of the first main body region 101 and the first bonding region 102 are as described above.

The first substrate 10 may be in a circular, triangular, rectangular or irregular shape, which is not listed one by one in the embodiments of the present disclosure. The implementation of the present disclosure is illustrated by taking an example where the first substrate 10 is in a shape of a rectangle.

As shown in FIGS. 18A to 18H, the second substrate 20 includes a second base 21 and a second electrode layer 22. The material of the second base 21 may be the same as that of the first base 11. For example, the materials of the first base 11 and the second base 21 both include glass. This may improve the consistency of the materials in the dimming panel 100 and reduce the manufacturing cost of the dimming panel 100.

The second electrode layer 22 is located on a side of the second base 21 proximate to the first substrate 10, and the second electrode layer 22 covers the second base 21. The material of the second electrode layer 22 may be the same as the material of the first electrode layer 12. For example, the materials of the first electrode layer 12 and the second electrode layer 22 both include ITO.

The dye liquid crystal layer 30 is located between the first substrate 10 and the second substrate 20. That is, the first electrode layer 12 is located on a side of the first base 11 proximate to the dye liquid crystal layer 30, and the second electrode layer 22 is located on a side of the second base 21 proximate to the dye liquid crystal layer 30.

As shown in FIGS. 18A to 18H, the plurality of spacers 40 are located between the first substrate 10 and the second substrate 20, and are disposed on the first substrate 10. The plurality of spacers 40 are used to support the first substrate 10 and the second substrate 20, so as to reduce a risk of uneven spacing between the first substrate 10 and the second substrate 20. In a case where the first substrate 10 includes the first electrode layer 12, the plurality of spacers 40 are disposed on the first electrode layer 12.

In some embodiments, as shown in FIGS. 18A to 18H, the plurality of spacers 40 are arranged in an array. The height of the spacer 114, the distance between the spacers 114 and the shape of the spacer 114 are as described above and will not be repeated here. For example, the spacer 40 is in a shape of a truncated cone.

FIGS. 18A to 18D are structural diagrams of the first edge sealant 50 including a first sub-portion 51. As shown in FIGS. 18A to 18D, the first edge sealant 50 includes the first sub-portion 51, and the first sub-portion 51 is located between the first substrate 10 and the second substrate 20, and is disposed along an edge of the second substrate 20 proximate to the first bonding region 102. The first sub-portion 51 is used to isolate the dye liquid crystal and the air, and the first sub-portion 51 may also reduce the risk of failure of the dimming panel 100 caused by moisture in the air entering the dye liquid crystal layer 30.

FIGS. 18E to 18H are structural diagrams of the first edge sealant 50 including a first sub-portion 51 and a second sub-portion 52. In some other embodiments, as shown in FIGS. 18E to 18H, the first edge sealant 50 includes the first sub-portion 51 and the second sub-portion 52. The first sub-portion 51 is located between the first substrate 10 and the second substrate 20, and is disposed along an edge of the second substrate 20 proximate to the first bonding region 102. The first sub-portion 51 is used to isolate the dye liquid crystal and the air, and the first sub-portion 51 may also reduce the risk of failure of the dimming panel 100 caused by moisture in the air entering the dye liquid crystal layer 30.

An orthographic projection of the second sub-portion 52 on the first substrate 10 is located within the first bonding region 102, and the second sub-portion 52 is disposed along an edge of the first bonding region 102 proximate to the second substrate 20. The second sub-portion 52 is connected to a sidewall of the first sub-portion 51 proximate to the first bonding region 102. In this way, the first edge sealant 50 has a relatively large size in a first direction Y1, which may further improve the problem of failure of the dimming panel 100 caused by moisture in the air entering the dye liquid crystal layer 30. The second sub-portion 52 is also bonded to a sidewall of the second substrate 20 proximate to the first bonding region 102. In this way, the second sub-portion 52 wraps the sidewall of the second substrate 20 proximate to the first bonding region 102, that is, the second sub-portion 52 isolates the sidewall of the second substrate 20 proximate to the first bonding region 102 from the air, which may reduce the risk of moisture entering the dimming panel 100 from the sidewall of the second substrate 20 proximate to the first bonding region 102, so as to reduce the risk of the material aging in the dimming panel 100, thereby prolonging the service life of the dimming panel 100. The first direction Y1 is parallel to the first substrate 10 and perpendicular to the first edge sealant 50.

In some embodiments, as shown in FIGS. 18A to 18H, the dimming panel 100 further includes a protective circuit board 60. The first circuit board 60 is located on a side of the first substrate 10 proximate to the second substrate 20, and an orthographic projection of the first circuit board 60 on the first substrate 10 is located within the first bonding region 102. In this way, the first circuit board 60 and the first electrode layer 12 may be electrically connected.

In some embodiments, as shown in FIGS. 18A to 18H, the dimming panel 100 further includes a first anisotropic conductive film (ACF) 5. The first anisotropic conductive film 5 is located between the first circuit board 60 and the first electrode layer 12. The first anisotropic conductive film 5 is used to bond the first circuit board 60 to the first electrode layer 12.

In some embodiments, as shown in FIGS. 18A to 18H, the dimming panel 100 further includes a first protective adhesive 70. At least a portion of the first protective adhesive 70 is located between the first edge sealant 50 and the first circuit board 60 and is bonded to the first edge sealant 50 and the first circuit board 60. The first protective adhesive 70 may enhance the firmness of the first circuit board 60 and the first electrode layer 12. Moreover, the first protective adhesive 70 isolates a portion of the first electrode layer 12 from the air, so as to reduce the risk of oxidation of the first electrode layer 12, thereby prolonging the service life of the first electrode layer 12. For example, a material of the first protective adhesive 70 includes ultraviolet adhesive.

FIGS. 18A to 18H are structural diagrams of a region formed by the first edge sealant 50, the first protective adhesive 70 and the first circuit board 60 covering the first bonding region 102. In some embodiments, as shown in FIGS. 18A to 18H, a region constituted by orthographic projections of the first edge sealant 50, the first protective adhesive 70 and the first circuit board 60 on the first substrate 10 covers the first bonding region 102. In this way, the first edge sealant 50, the first protective adhesive 70 and the first circuit board 60 work together to isolate the first electrode layer 12 located in the first bonding region 102 from the air, thereby reducing the risk of oxidation of the first electrode layer 12 located in the first bonding region 102.

As shown in FIGS. 18A to 18D, in a case where the first edge sealant 50 only includes the first sub-portion 51, the first protective adhesive 70 is also bonded to a sidewall of the second substrate 20 proximate to the first bonding region 102. In this way, the first protective adhesive 70 wraps the sidewall of the second substrate 20 proximate to the first bonding region 102, that is, the first protective adhesive 70 isolates the sidewall of the second substrate 20 proximate to the first bonding region 102 from the air, so as to improve the problem of the material aging of the dimming panel 100 caused by moisture in the air entering the dimming panel 100 through the sidewall of the second substrate 20 proximate to the first bonding region 102, and reduce the risk of failure of the dimming panel 100 caused by the material aging of the dimming panel 100, thereby prolonging the service life of the dimming panel 100.

FIG. 18A is a structural diagram showing the first substrate 10 having a first sidewall 103 and the second substrate 20 having a second sidewall 203. In some embodiments, as shown in FIG. 18A, the first substrate 10 has a first sidewall 103, the second substrate 20 has a second sidewall 203, the second sidewall 203 is substantially parallel to the first sidewall 103, and there is a gap between an orthographic projection of the second sidewall 203 on the first substrate 10 and the first sidewall 103. The dimming panel 100 further includes a second edge sealant 80, and the second edge sealant 80 includes a third sub-portion 81 and a fourth sub-portion 82. The third sub-portion 81 is located between the first substrate 10 and the second substrate 20 and is disposed along an edge of the second substrate 20 proximate to the second sidewall 203. The third sub-portion 81 is used to isolate the dye liquid crystal from the air. The third sub-portion 81 may also reduce the risk of failure of the dimming panel 100 caused by moisture in the air entering the dye liquid crystal layer 30.

As shown in FIG. 18A, the fourth sub-portion 82 is disposed along the second sidewall 203 and is bonded to the second sidewall 203. In this way, the fourth sub-portion 82 wraps the second sidewall 203, that is, the fourth sub-portion 82 isolates the second sidewall 203 from the air, which may reduce the risk of moisture invading the dimming panel 100 from the second sidewall 203 and reduce the risk of the material aging of the dimming panel 100, thereby prolonging the service life of the dimming panel 100. The fourth sub-portion 82 is connected to a sidewall of the third sub-portion 81 proximate to the fourth sub-portion 82. In this way, the second edge sealant 80 has a relatively large size in a second direction Y2, which may further improve the problem of failure of the dimming panel 100 caused by moisture in the air entering the dye liquid crystal layer 30. The second direction Y2 is parallel to the first substrate 10 and perpendicular to the second edge sealant 80.

As shown in FIG. 18A, an orthographic projection of the fourth sub-portion 82 on the first substrate 10 is located between the first sidewall 103 and the second sidewall 203. In this way, the fourth sub-portion 82 isolates the first substrate 10 located between the first sidewall 103 and the second sidewall 203 from the air, which may improve the problem of the material aging of the dimming panel 100 caused by moisture in the air entering the dimming panel 100 from the first substrate located between the first sidewall 103 and the second sidewall 203.

As shown in FIG. 18A, in a case where the first substrate 10 includes a first base 11 and a first electrode layer 12, the fourth sub-portion 82 isolates the first electrode layer 12 between the first sidewall 103 and the second sidewall 203 from the air, which may improve the problem of failure of the first electrode layer 12 caused by the first electrode layer 12 being oxidized, and reduce the risk of failure of the dimming panel 100 caused by the failure of the first electrode layer 12, thereby improving the service life of the dimming panel 100.

FIG. 18B is a structural diagram showing the first substrate 10 having a third sidewall 104 and the second substrate 20 having a fourth sidewall 204. As shown in FIG. 18B, the first substrate 10 has a third sidewall 104, and the second substrate 20 has a fourth sidewall 204. The third sidewall 104 is substantially parallel to the fourth sidewall 204, and an orthographic projection of the third sidewall 104 on the reference plane coincides with an orthographic projection of the fourth sidewall 204 on the reference plane. The dimming panel 100 further includes a third edge sealant 90. The third edge sealant 90 includes a fifth sub-portion 91. The fifth sub-portion 91 is located between the first substrate 10 and the second substrate 20 and is disposed along an edge of the first substrate 10 proximate to the third sidewall 104. The fifth sub-portion 91 is used to isolate the dye liquid crystal from the air. Moreover, the fifth sub-portion 91 may also reduce the risk of failure of the dimming panel 100 caused by moisture in the air entering the dye liquid crystal layer 30.

FIG. 18C is a structural diagram showing the third edge sealant 90 including a fifth sub-portion 91 and a sixth sub-portion 92. As shown in FIG. 18C, the third edge sealant 90 includes a fifth sub-portion 91 and a sixth sub-portion 92. The fifth sub-portion 91 is located between the first substrate 10 and the second substrate 20 and is disposed along an edge of the first substrate 10 proximate to the third sidewall 104. The fifth sub-portion 91 is used to isolate the dye liquid crystal from the air. Moreover, the fifth sub-portion 91 may also reduce the risk of failure of the dimming panel 100 caused by moisture in the air entering the dye liquid crystal layer 30. The sixth sub-portion 92 is disposed along the third sidewall 104 and the fourth sidewall 204.

As shown in FIG. 18C, the sixth sub-portion 92 is bonded to the third sidewall 104. In this way, the sixth sub-portion 92 wraps the third sidewall 104, that is, the sixth sub-portion 92 isolates the third sidewall 104 from the air, which may reduce the risk of moisture invading the dimming panel 100 from the third sidewall 104 and reduce the risk of the material aging of the dimming panel 100.

The sixth sub-portion 92 is also bonded to the fourth sidewall 204, that is, the sixth sub-portion 92 is bonded to the fourth sidewall 204. In this way, the sixth sub-portion 92 wraps the fourth sidewall 204, that is, the sixth sub-portion 92 isolates the fourth sidewall 204 from the air, which may reduce the risk of moisture invading the dimming panel 100 from the fourth sidewall 204 and reduce the risk of the material aging of the dimming panel 100. Furthermore, the service life of the dimming panel 100 may be prolonged.

As shown in FIG. 18C, the sixth sub-portion 92 is also connected to a sidewall of the fifth sub-portion 91 proximate to the third sidewall 104. In this way, the third edge sealant 90 has a relatively large size in a third direction Y3, which may further improve the problem of failure of the dimming panel 100 caused by moisture in the air entering the dye liquid crystal layer 30. The third direction Y3 is parallel to the first substrate 10 and perpendicular to the third edge sealant 90.

FIG. 18D is a structural diagram showing the first substrate 10 having a fifth sidewall 105 and the second substrate 20 having a sixth sidewall 205. As shown in FIG. 18D, the first substrate 10 has a fifth sidewall 105, the second substrate 20 has a sixth sidewall 205, the fifth sidewall 105 is substantially parallel to the sixth sidewall 205, and orthographic projections of the fifth sidewall 105, the sixth sidewall 205 and part of a sidewall of the dye liquid crystal layer 30 on the first substrate 10 are substantially flush. The dimming panel 100 further includes a fourth edge sealant 110. The fourth edge sealant 110 is disposed along the fifth sidewall 105, the sixth sidewall 205 and an edge of the dye liquid crystal layer 113 proximate to the fifth sidewall 105. In this way, the fourth edge sealant 110 is used to isolate the dye liquid crystal from the air. The fourth edge sealant 110 may also reduce the risk of failure of the dimming panel 100 caused by moisture in the air entering the dye liquid crystal layer 30.

The fourth edge sealant 110 is bonded to the fifth sidewall 105. In this way, the fourth edge sealant 110 wraps the fifth sidewall 105, that is, the fourth edge sealant 110 isolates the fifth sidewall 105 from the air, which may reduce the risk of moisture invading the dimming panel 100 from the fifth sidewall 105 and reduce the risk of the material aging of the dimming panel 100. The fourth edge sealant 110 is also bonded to the sixth sidewall 205. In this way, the fourth edge sealant 110 wraps the sixth sidewall 205, that is, the fourth edge sealant 110 isolates the sixth sidewall 205 from the air, which may reduce the risk of moisture invading the dimming panel 100 from the sixth sidewall 205 and reduce the risk of the material aging of the dimming panel 100.

In some embodiments, the second substrate 20 has a second main body region 201 and a second bonding region 202. As shown in FIG. 17, the second substrate 20 has a second main body region 201 and a second bonding region 202. The second bonding region 202 is located on a side of the second main body region 201. For example, the second bonding region 202 is located on an upper side, a lower side, a left side or a right side of the second main body region 201. An orthographic projection of the first substrate 10 on the second substrate 20 is located within the second main body region 201 and does not overlap with the second bonding region 202. The shape of the second substrate 20 may be the same as the shape of the first substrate 10.

The size of the second bonding region 202 may be set depending on actual conditions. For example, the second bonding region 202 is in a rectangular shape, and a dimension of the second bonding region 202 in a length direction of the second substrate 20 is equal to the length of the second substrate 20, alternatively, a dimension of the second bonding region 202 in a width direction of the second substrate 20 is equal to the width of the second substrate 20. As another example, a dimension of the second bonding region 202 in a length direction of the second substrate 20 is smaller than the length of the second substrate 20, alternatively, a dimension of the second bonding region 202 in a width direction of the second substrate 20 is smaller than the width of the second substrate 20.

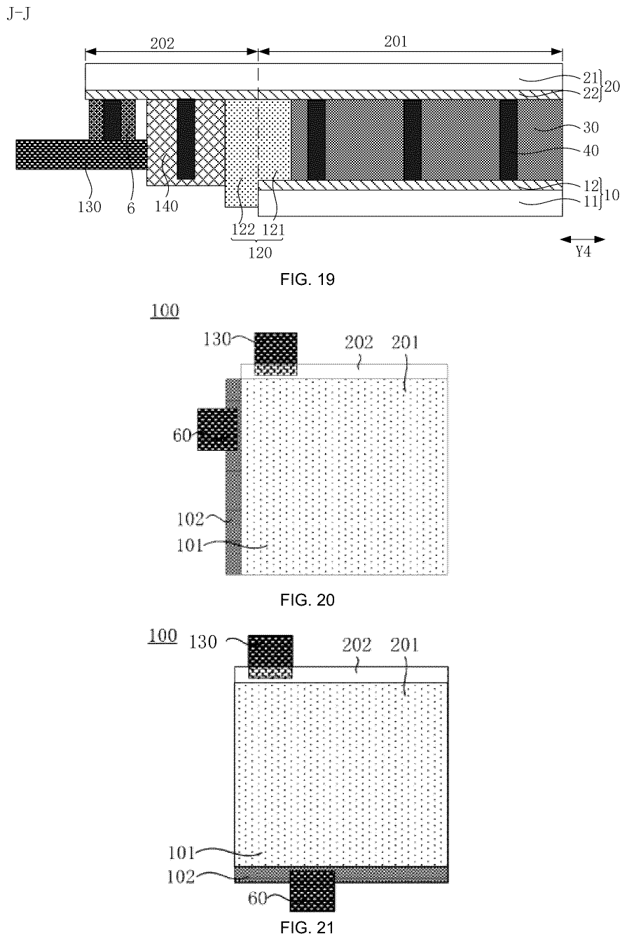

As shown in FIG. 19, the dimming panel 100 further includes a fifth edge sealant 120. The fifth edge sealant 120 includes a seventh sub-portion 121 and an eighth sub-portion 122. The seventh sub-portion 121 is located between the first substrate 10 and the second substrate 20, and is disposed along an edge of the first substrate 10 proximate to the second bonding region 202. In this way, the seventh sub-portion 121 is used to isolate the dye liquid crystal from the air. Moreover, the seventh sub-portion 121 may also reduce the risk of failure of the dimming panel 100 caused by moisture in the air entering the dye liquid crystal layer 30.

As shown in FIG. 19, an orthographic projection of the eighth sub-portion 122 on the second substrate 20 is located within the second bonding region 202. The eighth sub-portion 122 is disposed along an edge of the second bonding region 202 proximate to the first substrate 10, and is connected to a sidewall of the seventh sub-portion 121 proximate to the second bonding region 202. In this way, the fifth edge sealant 120 has a relatively large size in a fourth direction Y4, which may further improve the problem of failure of the dimming panel 100 caused by moisture in the air entering the dye liquid crystal layer 30. The fourth direction Y4 is parallel to the first substrate 10 and perpendicular to the fifth edge sealant 120.

As shown in FIG. 19, the eighth sub-portion 122 is bonded to a sidewall of the first substrate 10 proximate to the second bonding region 202. In this way, the eighth sub-portion 122 wraps the sidewall of the first substrate 10 proximate to the second bonding region 202, that is, the eighth sub-portion 122 isolates the sidewall of the first substrate 10 proximate to the second bonding region 202 from the air, which may reduce the risk of moisture entering the dimming panel 100 from the sidewall of the first substrate 10 proximate to the second bonding region 202 and reduce the risk of the material aging of the dimming panel 100.

In some embodiments, FIG. 19 is a structural diagram of the dimming panel 100 further including a second circuit board 130. As shown in FIG. 19, the dimming panel 100 further includes a second circuit board 130. The second circuit board 130 is located on a side of the second substrate 20 proximate to the first substrate 10, and an orthographic projection of the second circuit board 130 on the second substrate 20 is located within the second bonding region 202. In this way, the second circuit board 130 may be bonded to the second electrode layer 22.

In some embodiments, as shown in FIG. 19, the dimming panel 100 further includes a second anisotropic conductive film (ACF) 6. The second anisotropic conductive film 6 is located between the second circuit board 130 and the second electrode layer 22. The second anisotropic conductive film 6 is used to bond the second circuit board 130 to the second electrode layer 22.

In some embodiments, as shown in FIG. 19, the dimming panel 100 further includes a second protective adhesive 140. At least a portion of the second protective adhesive 140 is located between the fifth edge sealant 120 and the second circuit board 130 and is bonded to the fifth edge sealant 120 and the second circuit board 130. The second protective adhesive 140 may enhance the firmness of the second circuit board 130 and the second electrode layer 22. Moreover, the second protective adhesive 140 isolates a portion of the second electrode layer 22 from the air, so as to reduce the risk of oxidation of the second electrode layer 22, thereby prolonging the service life of the second electrode layer 22. The material of the second electrode layer 22 may be the same as that of the first electrode layer 12. For example, the material of the second protective adhesive 140 includes ultraviolet adhesive.

In some embodiments, as shown in FIG. 19, a region formed by orthographic projections of the fifth edge sealant 120, the second protective adhesive 140 and the second circuit board 130 on the second substrate 20 covers the second bonding region 202. In this way, the fifth edge sealant 120, the second protective adhesive 140 and the second circuit board 130 work together to isolate the second electrode layer 22 located in the second bonding region 202 from the air, thereby reducing the risk of oxidation of the second electrode layer 22 located in the second bonding region 202.

In some embodiments, the relative positions of the first circuit board 60 and the second circuit board 130 may be set depending on actual conditions.

For example, FIG. 17 is a structural diagram of arrangement on the same side of the first circuit board 60 and the second circuit board 130. As shown in FIG. 17, the first circuit board 60 and the second circuit board 130 are arranged at the same side. For example, the first circuit board 60 is located on the left side of the first main body region 101, and the second circuit board 130 is located on the left side of the second main body region 201. As another example, the first circuit board 60 is located on the right side of the first main body region 101, and the second circuit board 130 is located on the right side of the second main body region 201. As another example, the first circuit board 60 is located on the upper side of the first main body region 101, and the second circuit board 130 is located on the upper side of the second main body region 201. As another example, the first circuit board 60 is located on the lower side of the first main body region 101, and the second circuit board 130 is located on the lower side of the second main body region 201. Thus, in a case where the dimming panel 100 is in a rectangular shape, the first circuit board 60 and the second circuit board 130 are located on only one side of the dimming panel 100, which is beneficial to achieving a three-sided narrow frame design of the dimming panel 100.

Alternatively, for example, FIG. 20 is a structural diagram of adjacent arrangement of the first circuit board 60 and the second circuit board 130. As shown in FIG. 20, the first circuit board 60 and the second circuit board 130 are disposed adjacent to each other. The bonding process of the circuit board is simple and the production efficiency is high. For example, the first circuit board 60 is located on the left side of the first main body region 101, and the second circuit board 130 is located on the upper side or the lower side of the second main body region 201. As another example, the first circuit board 60 is located on the right side of the first main body region 101, and the second circuit board 130 is located on the upper side or the lower side of the second main body region 201.

Alternatively, for example, FIG. 21 is a structural diagram of opposite arrangement of the first circuit board 60 and the second circuit board 130. As shown in FIG. 21, the first circuit board 60 and the second circuit board 130 are arranged opposite to each other. The bonding process of the circuit board is simple and the production efficiency is high. For example, the first circuit board 60 is located on the left side of the first main body region 101, and the second circuit board 130 is located on the right side of the second main body region 201. As another example, the first circuit board 60 is located on the upper side of the first main body region 101, and the second circuit board 130 is located on the lower side of the second main body region 201.

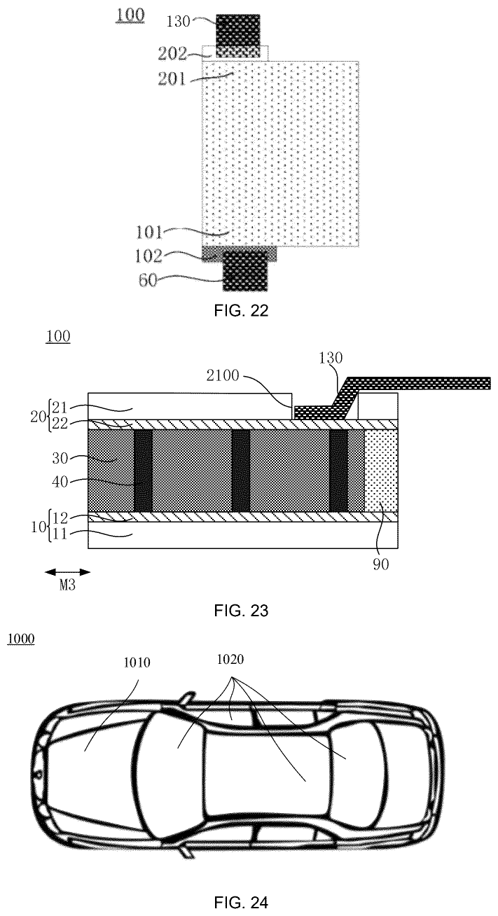

In some embodiments, the first bonding region 102 and the second bonding region 202 may be set depending on actual conditions. As shown in FIG. 22, the first bonding region 102 is in a rectangular shape, and a dimension of the first bonding region 102 in a width direction of the first substrate 10 is smaller than the width of the first substrate 10. The second bonding region 202 is in a rectangular shape, and a dimension of the second bonding region 202 in a width direction of the second substrate 20 is smaller than the width of the second substrate 20.

FIG. 23 is a structural diagram of a second base 21 provided with a through hole 2100. In some embodiments, as shown in FIG. 23, the second base 21 is provided with a through hole 2100 therein. The dimming panel 100 further includes a second circuit board 130. The second circuit board 130 is located on a side of the second substrate 20 away from the first substrate 10, and at least a portion of the second circuit board 130 passes through the through hole 2100 to be electrically connected to the second electrode layer 22. An orthogonal projection of the through hole 2100 on the dye liquid crystal layer 30 is located within the dye liquid crystal layer 30, that is, the through hole 2100 will not reduce a region of the dye liquid crystal layer 30, so as to maximize the region of the dye liquid crystal layer 30, that is, maximize a dimming region of the dimming panel 100. The dimming region refers to a region of the dimming panel 100 where the transmittance can be adjusted. The second circuit board 130 is located on a side of the second electrode layer 22 away from the first electrode layer 12, that is, the second circuit board 130 does not occupy an edge region between the first electrode layer 12 and the second electrode layer 22, which is beneficial to achieving the narrow frame design of the dimming panel 100.

In some embodiments, as shown in FIG. 18A, the spacers 40 are disposed on the first substrate 10, and at least part of orthographic projections of the spacers 40 on a plane where the second substrate 20 is located are located outside the second substrate 20.

For example, at least one spacer 40 is located in the first bonding region 102. In this way, in a case where the first protective adhesive 70 is formed in the first bonding region 102, at least one spacer 40 is located in the first protective adhesive 70, so as to increase a contact area of the first protective adhesive 70, thereby reducing a risk of the first protective adhesive 70 falling off from the first bonding region 102.

For example, at least one spacer 40 is located in the first bonding region 102. In this way, in a case where the first edge sealant 50 is formed in the first bonding region 102, at least one spacer 40 is located in the first edge sealant 50, so as to increase a contact area of the first edge sealant 50, thereby reducing a risk of the first edge sealant 50 falling off from the first bonding region 102.

In some embodiments, the embodiments of the present disclosure further provide a dimming structure. The dimming structure includes a dimming panel 100, and the dimming structure includes one of a daylighting roof, a curtain wall, a rail transit vehicle, a vehicle and a billboard.

The dimming panel 100 may be applied to an architecture field. For example, the dimming panel 100 is applied to the daylighting roofs and the curtain walls. The dimming panel 100 may be applied to partition glass. Compared with brick walls in the related technologies, the dimming panel 100 has a smaller thickness. The dimming panel 100 may save space, and a company logo may be displayed on the partition glass.

The dimming panel 100 may also be applied to a transportation field. For example, the dimming panel 100 is applied to the rail transit vehicles or the vehicles. The rail transit vehicles may include subways, light rail transits, air rail transits, trams and magnetic levitation trains, which are not listed one by one in the embodiments of the present disclosure. The vehicles may include passenger vehicles, commercial vehicles, trucks or buses, which are not listed one by one in the embodiments of the present disclosure.

FIG. 24 is a structural diagram of a vehicle. As shown in FIG. 24, the vehicle 1000 includes a vehicle body 1010 and window glass 1020 mounted on the vehicle body 1010. The window glass 1020 may be one or more of front window glass, sunroof glass, rear window glass or side window glass of the vehicle. The window glass 1020 includes the dimming panel 100 as described in any of the above embodiments. The dimming panel 100 may also be applied to a central control touch screen in the vehicle 1000.

The dimming panel 100 may also be applied to an advertising field. For example, the dimming panel 100 may be applied to billboards.

In the description of the specification, specific features, structures, materials or characteristics may be combined in any one or more embodiments or examples in a suitable manner.

The foregoing descriptions are merely specific implementations of the present disclosure, but the protection scope of the present disclosure is not limited thereto. Changes or replacements that any person skilled in the art could conceive of within the technical scope of the present disclosure shall be included in the protection scope of the present disclosure. Therefore, the protection scope of the present disclosure shall be subject to the protection scope of the claims.

1. A method for manufacturing a dimming panel, comprising:
forming a dimming panel motherboard, wherein the dimming panel motherboard includes a first substrate motherboard, a second substrate motherboard, a dye liquid crystal layer and a frame sealant; the first substrate motherboard and the second substrate motherboard are disposed opposite to each other; the dye liquid crystal layer is located between the first substrate motherboard and the second substrate motherboard; and the frame sealant is located between the first substrate motherboard and the second substrate motherboard and surrounds the dye liquid crystal layer;
cutting the dimming panel motherboard to form an initial dimming panel, wherein the initial dimming panel includes a first transition plate and a second transition plate, an orthographic projection of the second transition plate on a reference plane coincides with an orthographic projection of the first transition plate on the reference plane, and at least part of a sidewall of the first transition plate is flush with at least part of a sidewall of the dye liquid crystal layer; the reference plane is parallel to a surface of the first substrate motherboard proximate to the dye liquid crystal layer;
cutting the second transition plate along a first cutting line to form a second substrate, wherein the second substrate exposes a first region of the first transition plate, the first region forms a first bonding region; and the dye liquid crystal layer is located between the first transition plate and the second substrate; and
forming a first edge sealant along the first cutting line, wherein the first edge sealant includes a first sub-portion, and the first sub-portion is located between the first transition plate and the second substrate and is disposed along an edge of the second substrate proximate to the first bonding region.

2. The method according to claim 1, wherein
an orthographic projection of the first cutting line on the reference plane is located in an orthographic projection of the frame sealant on the reference plane; or
an orthographic projection of the first cutting line on the reference plane is located in an orthographic projection of the frame sealant on the reference plane; and forming the first edge sealant along the first cutting line includes:
removing a portion of the frame sealant located on a side of the first cutting line away from the dye liquid crystal layer along the first cutting line, wherein a portion of the frame sealant located between the first cutting line and a side of the dye liquid crystal layer forms the first sub-portion.

3. (canceled)

4. The method according to claim 1, wherein
an orthographic projection of the first cutting line on the reference plane is located in an orthographic projection of the dye liquid crystal layer on the reference plane; or
an orthographic projection of the first cutting line on the reference plane is located in an orthographic projection of the dye liquid crystal layer on the reference plane; and forming the first edge sealant along the first cutting line includes:
applying glue to form the first edge sealant, wherein a portion of the glue located between the dye liquid crystal layer and the first cutting line forms the first sub-portion; the first edge sealant further includes a second sub-portion, and another portion of the glue located in the first bonding region and extending along a sidewall of the second substrate proximate to the first bonding region forms the second sub-portion; the second sub-portion is connected to the first sub-portion.

5. (canceled)

6. The method according to claim 1, wherein after forming the first edge sealant along the first cutting line, the method further comprises:
bonding a first circuit board to the first bonding region of the first transition plate, wherein the first circuit board and the first edge sealant have a gap therebetween; and
after bonding the first circuit board to the first bonding region of the first transition plate, forming a first protective adhesive between the first circuit board and the first edge sealant, wherein the first protective adhesive is bonded to the first edge sealant and the first circuit board, and the first protective adhesive also covers a second region, and a region of the first bonding region exposed by the first circuit board and the first edge sealant forms the second region.

7. (canceled)

8. The method according to claim 1, wherein cutting the dimming panel motherboard to form the initial dimming panel includes:
pressing the dimming panel motherboard using a holddown; and
cutting the dimming panel motherboard along a second cutting line to form the initial dimming panel, wherein the holddown and the second cutting line have a gap therebetween.

9. The method according to claim 8, wherein during cutting the second transition plate to form the second substrate, the second transition plate is cut along an outer edge of the holddown; the second substrate further exposes a third region of the first transition plate, and a width of the third region is smaller than a width of the first region; the second substrate has a second sidewall, the first transition plate has a first sidewall, the second sidewall is substantially parallel to the first sidewall, and an orthographic projection of the second sidewall on the first transition plate and the first sidewall have a gap therebetween; and
during forming the first edge sealant, the method further comprises:
applying glue to form a second edge sealant, wherein the second edge sealant includes a third sub-portion and a fourth sub-portion, a portion of the glue located between the dye liquid crystal layer and the second sidewall forms the third sub-portion, and another portion of the glue located in the third region and extending along the second sidewall forms the fourth sub-portion; the fourth sub-portion is bonded to the second sidewall and connected to the third sub-portion, and an orthographic projection of the fourth sub-portion on the first transition plate covers the third region.

10. The method according to claim 8, wherein the second substrate has a fourth sidewall, the first substrate motherboard has a third sidewall, the third sidewall is substantially parallel to the fourth sidewall, and an orthographic projection of the third sidewall on the reference plane coincides with an orthographic projection of the fourth sidewall on the reference plane; and
during forming the first edge sealant, the method further comprises:
applying glue to form a third edge sealant, wherein the third edge sealant includes a fifth sub-portion and a sixth sub-portion, a portion of the glue located between the dye liquid crystal layer and the third sidewall forms the fifth sub-portion, and another portion of the glue extending along the third sidewall and the fourth sidewall forms the sixth sub-portion; the sixth sub-portion is bonded to the third sidewall and the fourth sidewall, and connected to the fifth sub-portion.

11. The method according to claim 1, wherein cutting the dimming panel motherboard to form the initial dimming panel includes:
cutting the dimming panel motherboard along a third cutting line to form a first dimming panel, wherein the first dimming panel has a panel region and a liquid leakage region, the liquid leakage region is located on at least one side of the panel region, and in the liquid leakage region, the dye liquid crystal layer and the frame sealant are not provided between the first substrate motherboard and the second substrate motherboard; and
cutting the first dimming panel along a fourth cutting line to form the initial dimming panel, wherein the fourth cutting line is located in the panel region;
the first substrate motherboard has a fifth sidewall, the second substrate has a sixth sidewall, and the fifth sidewall is substantially parallel to the sixth sidewall; an orthographic projection of the fifth sidewall on the first substrate motherboard, an orthographic projection of the sixth sidewall on the first substrate motherboard, and an orthographic projection of part of the sidewall of the dye liquid crystal layer are substantially flush; and
during forming the first edge sealant, the method further comprises:
applying glue to form a fourth edge sealant, wherein the glue forms the fourth edge sealant extending along the fifth sidewall, the sixth sidewall and the sidewall of the dye liquid crystal layer, and the fourth edge sealant is bonded to the fifth sidewall and the sixth sidewall.

12. (canceled)

13. (canceled)

14. A dimming panel, comprising:
a first substrate and a second substrate that are disposed opposite to each other, wherein the first substrate has a first bonding region, and an orthographic projection of the second substrate on the first substrate does not overlap with the first bonding region;
a dye liquid crystal layer located between the first substrate and the second substrate;
a plurality of spacers located between the first substrate and the second substrate; and
a first edge sealant including a first sub-portion, wherein the first sub-portion is located between the first substrate and the second substrate and is disposed along an edge of the second substrate proximate to the first bonding region.

15. The dimming panel according to claim 14, wherein the first edge sealant further includes a second sub-portion, an orthographic projection of the second sub-portion on the first substrate is located within the first bonding region, the second sub-portion is disposed along an edge of the first bonding region proximate to the second substrate, and is connected to a sidewall of the first sub-portion proximate to the first bonding region and bonded to a sidewall of the second substrate proximate to the first bonding region.

16. The dimming panel according to claim 14, further comprising:
a first circuit board, wherein an orthographic projection of the first circuit board on the first substrate is located within the first bonding region; and
a first protective adhesive, wherein at least a portion of the first protective adhesive is located between the first edge sealant and the first circuit board and is bonded to the first edge sealant and the first circuit board, wherein
a region constituted by orthographic projections of the first edge sealant, the first protective adhesive and the first circuit board on the first substrate covers the first bonding region.

17. (canceled)

18. The dimming panel according to claim 14, wherein the first substrate has a first sidewall, the second substrate has a second sidewall, the second sidewall is substantially parallel to the first sidewall, and an orthographic projection of the second sidewall on the first substrate and the first sidewall have a gap therebetween; and
the dimming panel further comprises:
a second edge sealant, including a third sub-portion and a fourth sub-portion, wherein the third sub-portion is located between the first substrate and the second substrate and disposed along an edge of the second substrate proximate to the second sidewall; and the fourth sub-portion is disposed along the second sidewall, and is bonded to the second sidewall and connected to a sidewall of the third sub-portion proximate to the fourth sub-portion; wherein
an orthographic projection of the fourth sub-portion on the first substrate covers a region between an orthographic projection of the first sidewall on the first substrate and the orthographic projection of the second sidewall on the first substrate.

19. The dimming panel according to claim 14, wherein the first substrate has a third sidewall, the second substrate has a fourth sidewall, the third sidewall is substantially parallel to the fourth sidewall, and an orthographic projection of the third sidewall on the first substrate coincides with an orthographic projection of the fourth sidewall on the first substrate; and
the dimming panel further comprises:
a third edge sealant, including a fifth sub-portion, wherein the fifth sub-portion is located between the first substrate and the second substrate and is disposed along an edge of the first substrate proximate to the third sidewall.

20. The dimming panel according to claim 19, wherein the third edge sealant further includes a sixth sub-portion, the sixth sub-portion is disposed along the third sidewall and the fourth sidewall, and is bonded to the third sidewall and the fourth sidewall and connected to a sidewall of the fifth sub-portion proximate to the third sidewall.

21. The dimming panel according to claim 14, wherein the second substrate has a second bonding region, and an orthographic projection of the first substrate on the second substrate does not overlap with the second bonding region; and
the dimming panel further comprises:
a fifth edge sealant, including a seventh sub-portion and an eighth sub-portion, wherein the seventh sub-portion is located between the first substrate and the second substrate and disposed along an edge of the first substrate proximate to the second bonding region; an orthographic projection of the eighth sub-portion on the second substrate is located within the second bonding region; the eighth sub-portion is disposed along an edge of the second bonding region proximate to the first substrate, and is connected to a sidewall of the seventh sub-portion proximate to the second bonding region and bonded to a sidewall of the first substrate proximate to the second bonding region; and
a second circuit board, wherein an orthographic projection of the second circuit board on the second substrate is located within the second bonding region.

22. The dimming panel according to claim 21, further comprising:
a second protective adhesive, wherein at least a portion of the second protective adhesive is located between the fifth edge sealant and the second circuit board and is bonded to the fifth edge sealant and the second circuit board.

23. The dimming panel according to claim 22, wherein a region constituted by orthographic projections of the fifth edge sealant, the second protective adhesive and the second circuit board on the second substrate covers the second bonding region.

24. The dimming panel according to claim 14, wherein the second substrate includes:
a second base provided with a through hole therein; and
a second electrode layer located on a side of the second base proximate to the dye liquid crystal layer, the second electrode layer covering the second base; and
the dimming panel further comprises:
a second circuit board located on a side of the second substrate away from the first substrate, wherein at least a portion of the second circuit board passes through the through hole to be electrically connected to the second electrode layer.

25. The dimming panel according to claim 14, wherein the spacers are disposed on the first substrate, and at least part of orthographic projections of the spacers on a plane where the second substrate is located are located outside the second substrate; wherein
at least one spacer is located in the first bonding region.

26. (canceled)

27. A dimming structure, comprising the dimming panel according to claim 14, wherein the dimming structure comprises at least one of a curtain wall, a daylighting roof, a rail transit vehicle and a passenger vehicle.
